(19) United States
(12) Patent Application Publication
(10) Pub. No.: US 2026/0139500 A1
(43) Pub. Date: May 21, 2026

(54) FASTENER GUIDE

(71) Applicant: Illinois Tool Works Inc., Glenview, IL (US)

(72) Inventor: Bernard Joseph KENNELLY, AvalonBeach (AU)

(21) Appl. No.: 19/391,767

(22) Filed: Nov. 17, 2025

(30) Foreign Application Priority Data
Nov. 19, 2024 (AU) 2024903815
Oct. 31, 2025 (AU) 2025259961

(51) Int. Cl. E04G 21/18; B67B 7/16

(52) U.S. Cl. CPC E04G 21/1891; B67B 7/16

(57) ABSTRACT

A guide for installation of a fastener to secure structural members, the guide comprising: a base having at least one surface configured to abut a first structural member; at least one engagement projection extending from the surface of the base and configured to abut a side of the first structural member; and at least one fastener receiver extending in a direction opposite from the at least one surface of the base, wherein, when the base and projection are each abutting the first structural member, the receiver is located to guide a fastener placed therein to secure the first structural member and a second structural member together, and, as the fastener secures the structural members, the guide is removable therefrom.

### PRIORITY CLAIM

This application claims priority to and the benefit of Australian Patent Application No. 2024903815, filed Nov. 19, 2024, and Australian Patent Application No. 2025259961, filed Oct. 31, 2025, the entire contents of each of which are incorporated herein by reference.

### RELATED APPLICATION

This application relates to co-pending U.S. Design Patent Application No. 30/003,499, filed May 13, 2025, entitled FASTENER GUIDE, Attorney Docket No. 025140-2525/71212-US-DS.

### TECHNICAL FIELD

The present disclosure relates to the installation of structural members within a building structure. More particularly, the present disclosure relates to a guide for locating a fastener with respect to first and second structural members, such as first and second truss members, which may be connected together, such that a fastener driven or applied into the structural members to secure the members together is correctly positioned, e.g. relative to such a connection. The present disclosure also relates to a method of securing a first structural member to a second structural member using the guide. The present disclosure has particular, though not exclusive, application to the installation of roof trusses.

### BACKGROUND

Assembly of a structural framework of a building, particularly a timber framework, typically involves brackets installed in situ so as to interconnect members or components in the framework. In one exemplary known arrangement, shown in FIG. 1A, a first structural member in the form of an extension of a top chord TC1 of a first timber roof truss T1 is secured to an abutting second structural member in the form of a top plate TC2 of a wall frame T2 via a bracket B secured against the truss T1 and frame T2 via fasteners F (typically comprising nails or screws) received through the bracket B, thereby interconnecting structural members T1, T2 at connection C. Alternatively, conventional brackets used to interconnect members of the framework may be configured with teeth which are driven into the members to secure the bracket to the members.

Installer skill is critical for correct bracket location and for fixing the brackets. The structural members TC1, TC2, each normally having a rectangular cross-section, often extend at oblique angles relative to each other, often both in a horizontal plane and a vertical plane such that none of the top, bottom and side faces of the chord TC1 is perpendicular or parallel to the top, bottom and side faces of the top plate TC2. In consequence, installers must often, while operating at height, manually bend or manipulate brackets or nail plates to conform to the relative orientation of the structural members when installing the brackets to thereby interconnect chords. However, such bending or manipulation of the brackets, particularly when an end of one of two chords (or other structural members) that extend obliquely relative to each other abuts a side of the other of the chords where the chords are to be interconnected, can adversely affect the integrity of both the brackets and the securement thereof to the chords (or other structural members). In consequence, although the appropriate location of the brackets may be able to be confirmed by visual inspection after installation or assembly, the integrity and adequacy of the fastening of the brackets to the members to which they are attached during installation or assembly often cannot be.

Moreover, the installation of the brackets to interconnect structural members, particularly when the brackets must be manually bent or manipulated to conform to the relative orientation of the to-be-interconnected structural members, can typically require large quantities of installer time. An exemplary arrangement of a hip end of a roof framework RF is shown in FIG. 1B, with connections C circled. The roof framework RF comprises interconnected jack trusses, creeper trusses, creeper rafters, hip trusses, truncated girder trusses, truncated standard trusses and standard trusses arranged on and secured to a timber top plate TP of a wall frame. The installation of the hip end requires over 20 connections C between obliquely extending structural members of the trusses, only some of which are indicated in FIG. 1B. Many houses typically comprise two or three hip ends.

Accordingly, the securement of structural members in the conventional manner using brackets can result in non-compliant and unsafe connections and/or prolonged time working at height for the installer.

Our prior Australian Patent Application No. 2017221792 discloses an alternative method of assembling a building structure in which a truss may be connected to a structural component without using the brackets B, the method comprising fixing together the abutting truss and component with at least one fastener which has been pre-applied to one of the truss or the component by driving the fastener, which may be a screw or nail, into the other of the truss and the component.

Further, our prior Australian Patent Application No. 2021201323 discloses a method for drilling holes for pre-applied fasteners, such as during the prefabrication of trusses, whereby a fastener received, and which may be pre-applied, in the hole is correctly positioned and orientated in the truss.

The disclosure in each of the specifications of AU 2017221792 and AU 2021201323, as originally filed, is incorporated by reference.

If the structural members are supplied on site without pre-drilled holes for fasteners, and/or without fasteners pre-applied therein/thereto, however, installer skill is again critical to ensure correct position and orientation of the fasteners, particularly when securing structural members together that extend obliquely relative to one another, to thereby ensure integrity of the connection between the members and avoid non-compliant and unsafe connections. Further, installers may again be required to work prolonged times at height to correctly position and orientate fasteners prior to and while driving the fasteners into the structural members.

The present disclosure was conceived with the above shortcomings in mind, and an embodiment of the present disclosure seeks to ameliorate one or more of these difficulties.

Alternatively or additionally, an embodiment of the present disclosure seeks to at least provide the public with a useful choice.

### SUMMARY

According to a first aspect of the present disclosure, there is provided a guide for installation of a fastener to secure structural members, the guide comprising: a base having at least one surface configured to abut a first structural member; at least one engagement projection extending from the surface of the base and configured to abut a side of the first structural member; and at least one fastener receiver extending in a direction opposite from the at least one surface of the base, wherein, when the base and projection are each abutting the first structural member, the receiver is located to guide a fastener placed therein to secure the first and a second structural member of the truss together, and, as the fastener secures the structural members, the guide is removable therefrom.

According to a second aspect of the present disclosure, there is provided a guide for guiding a fastener for connecting first and second structural members together, the first structural member having: one face which engages the second structural member; a second face which, in use, is penetrated by the fastener; and third and fourth faces located laterally of the first and second faces, the guide including: a base; at least one fastener receiver; and at least one engagement projection, and the arrangement being such that, in use, the base engages the second face and said at least one engagement projection engages said third or fourth face.

Advantageously, a guide according to the first or second aspect allows a worker to fasten members of a truss together with improved speed, productivity, accuracy, and quality. The inclusion of the projection allows the guide to be simply positioned centrally about the width of the upper truss member, thus ensuring the fastener guided into the member is accurately positioned therein. The receiver enables a user to hold the fastener before positioning the guide, and thus reduces the chances of any guide movement between positioning and fastening of the fastener. Furthermore, the receiver acts as a guide itself, in that the receiver directs the fastener into the truss members in a perpendicular manner, ensuring that fastener accurately penetrates both truss members being secured together. The guide being removable from the fastener as the fastener secures the truss members means that the guide can be reused multiple times, and does not have to be a disposable tool or component. This is particularly useful due to the large number of required connections between structural members in typical roof trusses and the like.

In some embodiments, the at least one engagement projection is configured to abut a side of the second structural member, wherein the side of the first structural member extends transversely relative to the side of the second structural member. The side of the first structural member may extend perpendicular relative to the side of the second structural member. The at least one surface of the base may comprise first and second surfaces, the first surface extending at a first angle relative to an axis the fastener is guided along, and the second surface extending at a second angle relative said axis, wherein the first angle is different to said second angle.

In some embodiments, the or each receiver partially surrounds the fastener in use. The or each receiver may include an opening along its length to partially surround the received fastener, the received fastener being removable through the opening. The or each receiver may include a sidewall which defines an elongate recess for receiving the fastener. The sidewall may include a part cylindrical portion. The elongate recess may have an open end through which the fastener can be introduced into the recess. The open end may include a ramp, the ramp configured to displace a head of the fastener to remove the fastener from the receiver when the head of the fastener bears thereagainst. The open end of the receiver may be slanted to form said ramp. The base may comprise a slot aligned with said opening, the slot for removal of the fastener from the guide. The fastener receiver may be elongate and extend from the base in a direction opposite to said engagement projection. The receiver may extend in a perpendicular direction relative to the base. The ramp may be configured such that the head of the fastener engages the abutment ramp when driven into a structural member to displace the guide laterally relative to the fastener. When displaced by the ramp, the fastener may be able to press through said slot to thereby disengage the guide from the fastener.

In some embodiments, the or each receiver is sized to receive the fastener without binding thereagainst. The guide may comprise a pair of (first and second) projections, the pair of projections configured to each abut a separate side of the structural member to locate the receiver. The or each projection may extend substantially but not more than a length of the sides of both structural members. The guide may further comprise a support connecting the base to the or each receiver and/or to the or each projection for supporting the extension of the or each receiver and/or the or each projection. The base may include a flat portion for engaging a horizontal member, and an inclined portion for engaging an angled member. The flat portion of the base may extend substantially horizontally, and the inclined portion may extend at angle thereto. The guide may include two fastener receivers, one extending from said flat portion of the base and the other extending from said inclined portion of the base. The or each engagement projection may comprise a substantially L shaped cross-section. The guide may include a bottle opening means. A body of the guide may comprise two spaced apart apertures for each retaining a portion of a shank of a respective elongate fastener to thereby define bottle opening means.

According to a third aspect of the present disclosure, there is provided a method of securing structural members, using a guide according to the first or second aspect, the method comprising the steps of: abutting a surface of the base of the guide to a first structural member and abutting the or each engagement projection to a side of the first structural member, thereby locating at least one of the at least one receivers; and driving a fastener through the at least one receiver located to guide the fastener, the fastener securing each structural member together.

In the description in this specification, reference may be made to subject matter which is not within the scope of the appended claims. That subject matter should be readily identifiable by a person skilled in the art and may assist in putting into practice the present disclosure as defined in the presently appended claims.

### BRIEF DESCRIPTION OF THE DRAWINGS

The present disclosure will now be described, by way of non-limiting example only, with reference to the accompanying drawings.

FIG. 1A shows an exemplary known bracket connecting structural members together.

FIG. 1B shows an exemplary known arrangement of a hip end of a roof framework.

FIG. 1 is a schematic front perspective view drawing of a guide in accordance with an embodiment of the present disclosure.

FIG. 2 is a schematic rear perspective view drawing of the guide shown in FIG. 1.

FIG. 2A is a schematic perspective view drawing of an alternative guide.

FIG. 3 is a schematic front view drawing of the guide shown in FIG. 1.

FIG. 4 is a schematic rear view drawing of the guide shown in FIG. 1.

FIG. 5 is a schematic right side view drawing of the guide shown in FIG. 1.

FIG. 6 is a schematic left side view drawing of the guide shown in FIG. 1.

FIG. 7 is a schematic top view drawing of the guide shown in FIG. 1.

FIG. 8 is a schematic bottom view drawing of the guide shown in FIG. 1.

FIG. 9A is a schematic perspective view drawing of the guide shown in FIG. 1, the guide receiving a fastener in a first fastener receiver thereof.

FIG. 9B is a schematic perspective view drawing of the guide shown in FIG. 1, the guide receiving a fastener in a second fastener receiver thereof.

FIGS. 10 to 17 are schematic perspective view drawings of a guide being used to secure truss members in accordance with an embodiment of the present disclosure.

FIGS. 18A to 18C are schematic top view drawings of a guide being used to secure truss members in accordance with another embodiment of the present disclosure.

FIGS. 19 and 20 are schematic enlarged partial view drawings of a guide in accordance with an embodiment of the present disclosure.

FIGS. 21 and 22 are schematic perspective views of a guide including a bottle opening means, in accordance with an embodiment of the present disclosure.

FIG. 23 is a perspective view of a connection formed between first and second truss members.

FIG. 24 is a flowchart showing a method of securing chords of a truss using a guide in accordance with an embodiment of the present disclosure.

FIGS. 25A, 25B, and 26 to 33 are schematic perspective view drawings showing a guide being used in accordance with the flowchart/method of FIG. 24.

### DETAILED DESCRIPTION

While the systems, devices, and methods described herein may be embodied in various forms, the drawings show, and the specification describes certain exemplary and non-limiting embodiments. Not all components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

In the following detailed description, reference is made to accompanying drawings which form a part of the detailed description. It will be readily understood that the aspects of the present disclosure, as generally described herein and illustrated in the drawings may be arranged, substituted, combined, separated, and designed in a wide variety of different configurations, all of which are contemplated in this disclosure.

Unless defined otherwise, all technical and scientific terms used herein have the same meaning as commonly understood by one of ordinary skill in the art to which this present disclosure belongs. Although any methods and materials similar or equivalent to those described herein can also be used in the practice or testing of the present disclosure, a limited number of the example methods and materials are described herein.

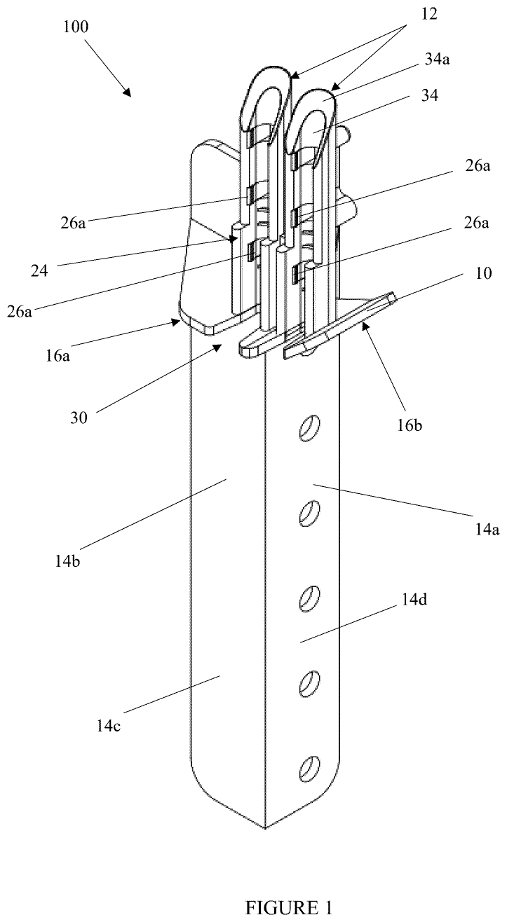

A guide 100 for locating and installing a fastener 200, by guiding the fastener 200, to secure or connect first and second structural members 300, 400 together within a building structure to interconnect and thereby form a connection between the members 300, 400 according to an embodiment of the present disclosure is shown schematically in FIGS. 1 to 23.

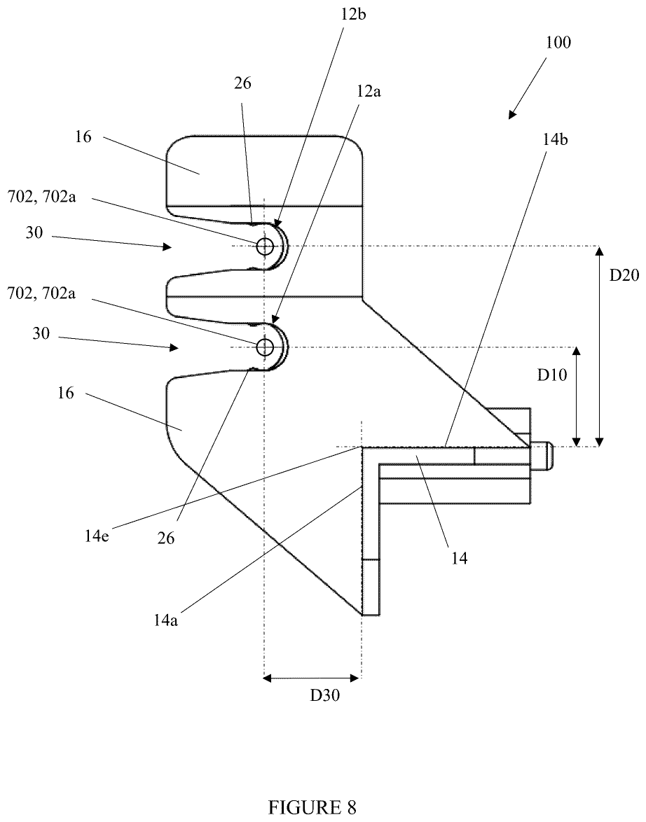

The guide 100 is particularly suitable for connecting structural members of in situ roof trusses, typically timber roof trusses, to and/or as part of a roof framework, together. With reference to FIG. 10, the first structural member 300 may be a top chord, such as an extension of a top chord of a first truss, and the second structural member 400 may similarly be the top chord of a second truss, with a plane of the first truss typically extending transversely (perpendicularly or obliquely) relative to a plane of the second. In FIG. 10, the member 300 is shown extending perpendicularly with respect to the second member 400. The first truss may be, for example, a creeper truss or a jack truss, the second truss may be, for example, a standard truss, a truncated standard truss, a truncated girder truss, or a Dutch hip girder truss, and vice versa. Alternatively, and by way of non-limiting example only, each of the first and/or second structural members 300, 400 may be another member or component of a roof truss, such as a bottom chord or a web of a truss, or other member or component of a building framework/structure, such as a top plate of a wall frame. Alternatively, each of the each of the first and/or second structural members 300, 400 may be, or be part of, other rigid structures such as is utilized in the construction of building structures, including roofs. The members 300, 400 are preferably wooden members, such as timber, but may also be metal members, such as those formed from steel. Alternatively, the members 300, 400 may be formed from other suitable material(s) used in building structures.

The structural members 300, 400 shown in the Figures are in the form of elongate timber prisms or beams each having a substantially constant rectangular cross-section along the length of the prism or beam. With reference to FIG. 10, for example, the first structural member 300 has: a first face (or side or surface) 330 (such as a bottom face), and a second face (or side or surface) 310 (such as a top face) opposite the first face 330, opposed third and fourth faces (or sides or surfaces) 320a, 320b (such as side faces) located laterally/defining longitudinally extending edges of the first and second faces 330, 310, and a width W300 and a thickness or depth T300. The second structural member 400 similarly has: a first face or (or side or surface) 430, and a second face (or side or surface) 410 opposite the first face 430, third and fourth faces (or sides or surfaces) 420a, 420b located laterally/defining longitudinally edges of the first and second faces 430, 410, and a width W400 and a thickness or depth T400. In particular, for example, the face 330 abuts a longitudinally extending edge 420 defined by the faces 410, 420a. As will be discussed below, a fastener 200 can be driven, guided by the guide 100, to penetrate the face 310 and then driven through the member 300 and into the second member 400, thereby securing the members together. By way of non-limiting example only, a member 300 (or member 400) in the form of a component (e.g. a chord or web) of a typical Australian truss member may have a width W300 (or W400) of about 90 mm and a thickness T300 (or T400) of about 35 mm. Alternatively, again by way of non-limiting example only, a member 300 (or member 400) in the form of a chord of a typical New Zealand truss member may have a width W300 (or W400) of about 90 mm and a thickness T300 (or T400) of about 45 mm. It will be understood, the guide 100 may be configured for use with members 300, 400 having other width/thickness dimensions, and members 300, 400 that do not have to have the same width/thickness dimensions as each other. For example, the width at least of one the members 300, 400, such as when that member is a top plate may alternatively be 70 mm or 120 mm. Further, one or both of the members 300, 400 may have other than a constant rectangular cross-section along a length thereof.

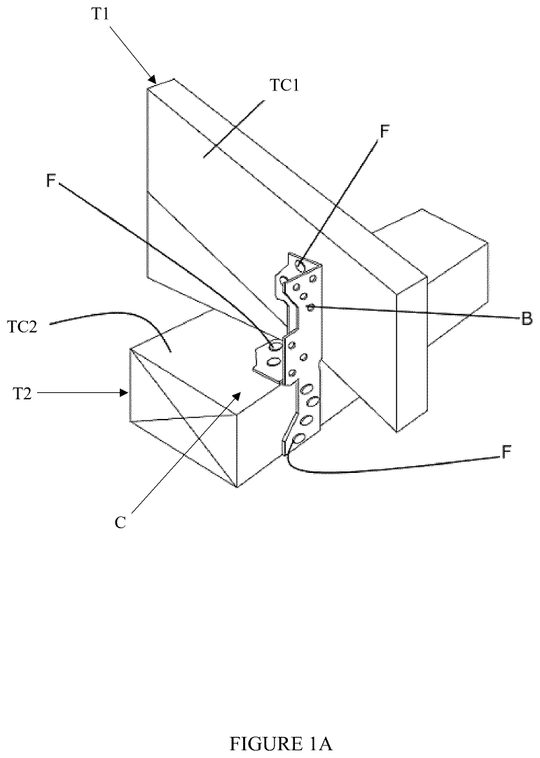

Looking to FIGS. 1 and 2 in particular, the guide 100 can be seen to have a unitary body comprising/defining a base 10, at least one fastener receiver 12, and at least one engagement or locating projection 14. The base 10 has at least one surface 16 configured in use of the guide to typically abut either top face 310 of the member 300 or bottom face 430 of the member 400. The at least one engagement projection 14 extends from the surface 16 of the base 10 and is configured in use of the guide to engage or abut a side face 320a or 320b of the member 300 and a side face 420a or 420b of the structural member 400. The at least one fastener receiver 12 extends in a direction opposite from the surface 16 of the base 10. The or each fastener receiver 12 is configured to define a fastener guide axis 702 that extends through and is substantially coaxial with an elongate fastener 200 located the receiver 12 and that the fastener 200 is guided along when driven into the member 300. The example guide 100 comprises two fastener receivers 12a, 12b defining parallel respective axes 702 that fasteners can be guided along. In the example guide 100, each of the guide axes 702 corresponds to a longitudinal axis 702a of the respective receiver 12.

The arrangement of the guide 100 is such that, when the base 10 and projection/s 14 are each engaging or abutting the structural member 300 to locate the guide 100 relative to the abutting structural members 300, 400, as will be described below, the/each receiver 12 is correctly located, positioned and orientated, to guide a fastener 200 placed therein and driven therethrough to secure the structural members 300, 400 together. As the fastener 200 is being driven through the receiver 12 and into the member 300 to secure the structural members 300, 400 together, the guide 100 is removable therefrom.

The guide 100 shown in the Figures is formed from a polymer, in particular an injection moulded plastic. Advantageously, forming the guide 10 in this way allows it to be relatively low cost and relatively easy to manufacture in relatively large volumes, as well as preferably providing some weathering resistance to UV light exposure and high temperatures. Furthermore, utilizing moulded plastics allows the colour of the guide 100 to be easily changed. In practice, it is contemplated that the guide 100 will be brightly coloured so to assist with visibility of the guide 100 to users thereof. The guide 100 could be formed using alternative manufacturing methods from injection moulding, such as, for example, additive manufacturing such as 3D printing. The material of the guide 100 could also be formed from metals or other materials, and it is only being preferred and/or required that the material/s be ones which are sufficiently/relatively rigid and strong to allow repeated use of the guide before requiring replacement.

Looking again to FIGS. 1 and 2, the base 10 of the guide 100 can be seen. The base 10 includes a first locater in the form of a locating surface 16, in use on the underside (or topside) of the base 10, which abuts the member 300 (or member 400). The base 10 is a substantially planar component of the guide 100, and acts to support the guide 100 in, for example, an upright position when the base's locating surface 16 is received against, or abuts and/or rests on, the face 310 of the first structural member 300. In this way, the planar or flat surface 16 of the base 10 provides for a fastener 200 located in the receiver 12 to extend normal to the longitudinal axis 704 of the member 300. The surface 16 of the base 10 is sized to extend across a suitably large portion of the width of the face 310 so as to support the guide 100, in particular the receiver 12, in location.

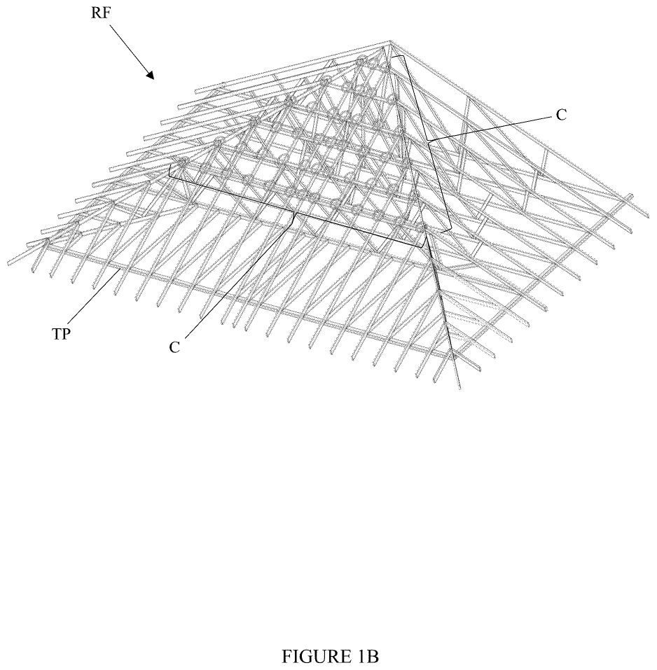

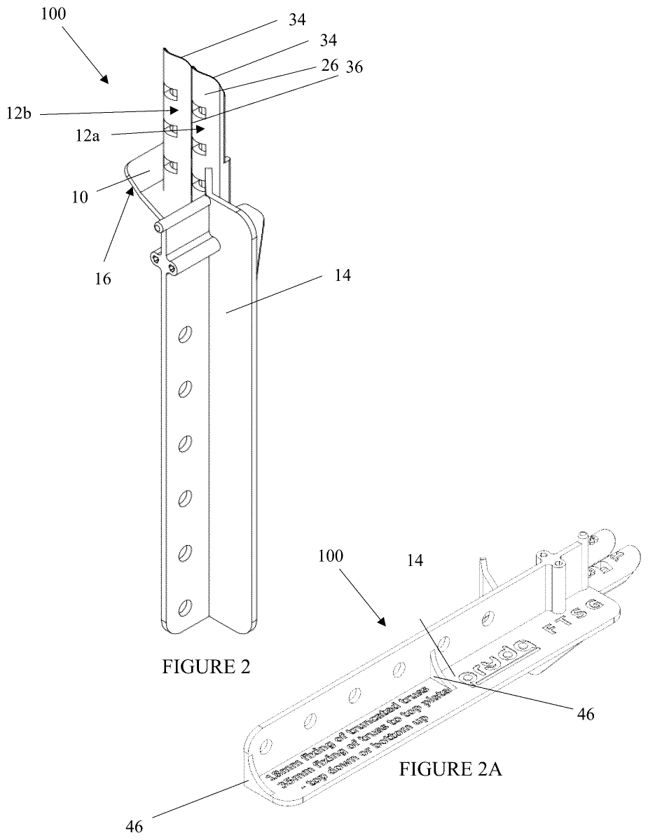

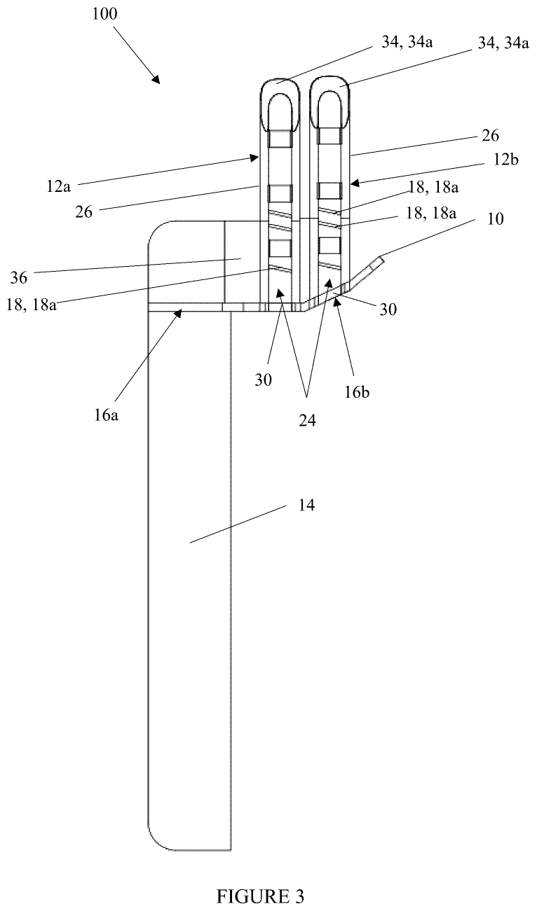

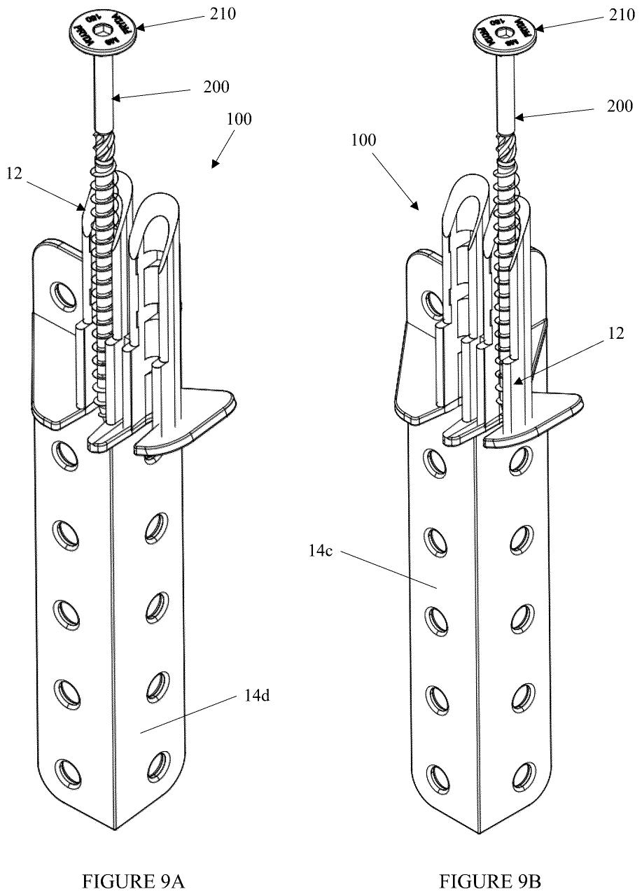

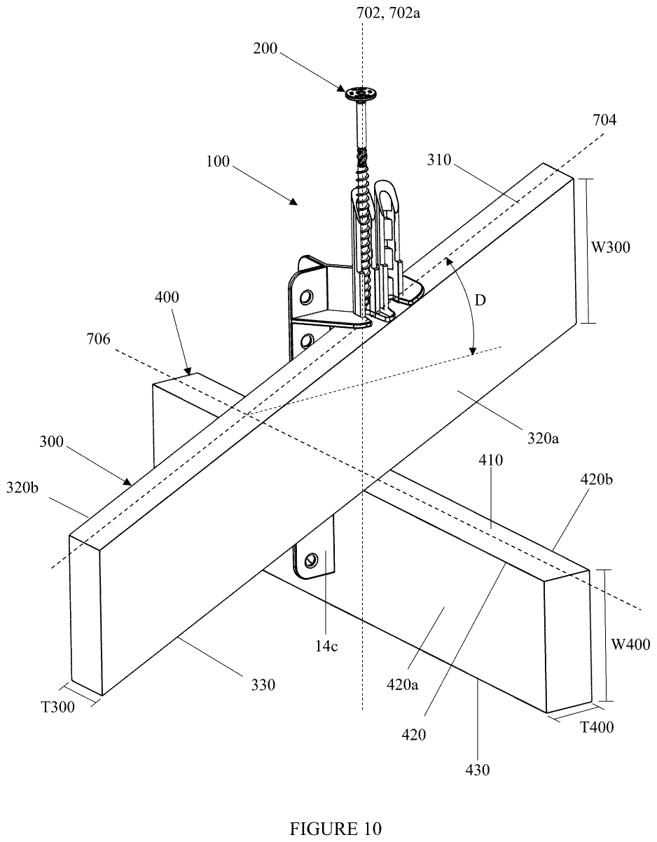

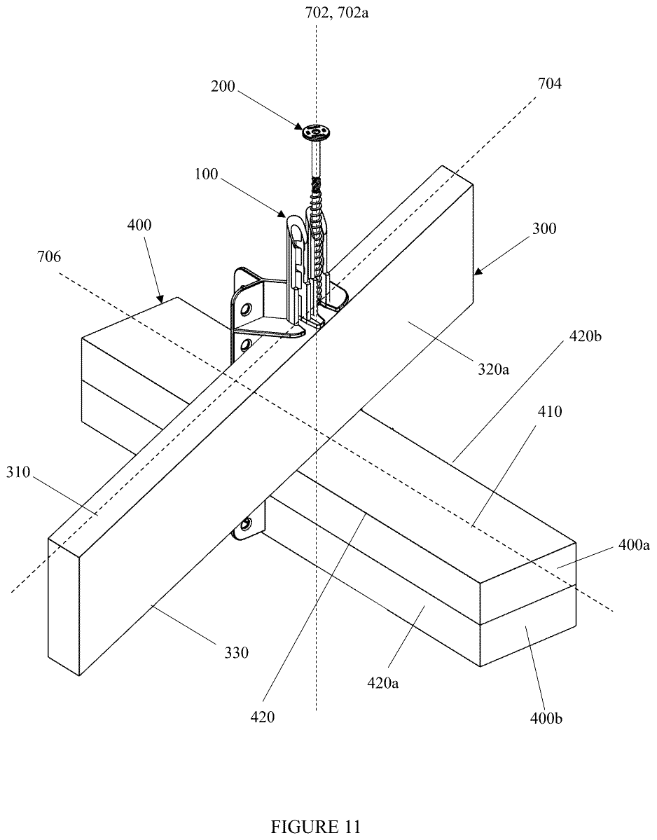

In the Figures, in particular FIGS. 3 and 5, it can be seen that the locating surface 16 of the base includes a locating datum in the form of a first, preferably flat/planar, portion 16a and a locating datum in the form of an inclined second, preferably flat/planar, portion 16b. The portion 16a extends obliquely with respect to the portion 16B. The portion 16a extends in a plane transversely, and more particularly perpendicularly/normal, with respect to the guide axes 702. The portion 16b provides for the aforementioned normal-direction extension relative to the longitudinal axis 704 of the member 300 when that extension is also normal relative to the longitudinal extension of the engagement member 14 relative to the base 10 (e.g., for engaging a top plate from below, such as in FIGS. 13-17). The portion 16b extends in a plane transversely, and more particularly obliquely, with respect to the axes guide 702. The portion 16b provides for the aforementioned normal extension relative to the longitudinal axis 704 of the member 300 when that extension is inclined relative (rather than normal to) the longitudinal extension of the engagement member 14 relative to the base 10 (e.g., for engaging a truncated girder truss from above, such as in FIGS. 11 and 12). This allows the guide 100 to be used, for example, both when the longitudinal axis 704 of the first structural member 300, when in situ, is substantially horizontal and when that axis 704 is inclined/extending obliquely relative to the horizontal. With reference to the example arrangement of the members 300, 400 shown in FIG. 10, for example, when the guide is 100 used to locate and guide a fastener to secure the structural members 300, 400 together, the surface 16 (portion 16B in FIG. 10) is configured to abut/contact the face 310. The plane in which the portion/surface 16b extends makes an Angle B with the plane in which the portion/surface 16a extends. In preferred embodiments, this Angle B between 15-35 degrees, more particularly between 20-30 degrees, more particularly is about 25 degrees, as shown in FIG. 4.

In some embodiments of the guide 100, such as is shown in FIG. 4, the locating surface 16 of the base 10 may include a further inclined, preferably flat/planar, portion (i.e., a third locating datum) 16c. The plane in which the portion/surface 16c extends makes an Angle C with the plane in which the portion/surface 16a extends. In preferred embodiments, this Angle C is between 35-55 degrees, more particularly between 40-50 degrees, more particularly about 45 degrees. The surface 16 of the example guide 100 transitions, in a direction away from the surface 14a, from portion 16a (extends in a plane transversely, and more particularly perpendicularly/normal, with respect to the guide axes 702), to portion 16b (Angle B), and to portion 16c (Angle B).

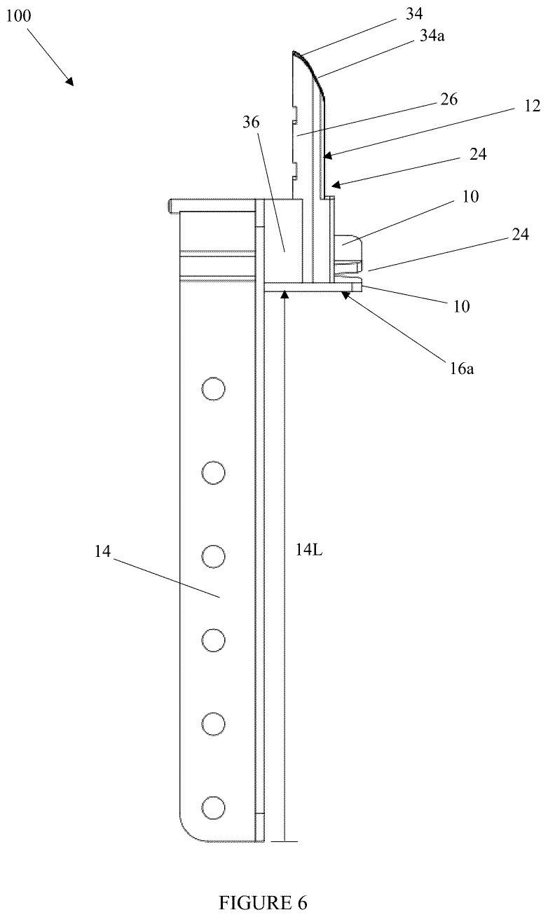

Extending from or adjacent the base 10, the guide 100 includes a second locator in the form of the (at least one) engagement or locating projection 14. The elongated projection 14 is provided in the form of a leg, and extends downwardly (as shown in FIG. 1) from the surface 16 of the base 10, in an opposite direction to the direction(s) the receivers 12 extend from the surface 16/base 10. The projection 14 is located/positioned about or proximate to an outer edge or periphery of the base 10. Alternatively (not shown), the projection 14 may be spaced from, but connected to, an outer edge or periphery of the base 10. With reference to FIG. 8, the projection 14 has a locating datum in the form of a surface (or face or edge) 14a and a second locating datum in the form of a surface (or face or edge) 14b, the first face extending transversely, more particularly perpendicularly, with respect to the second surface. Turning back now to FIG. 2, the example projection 14 can be seen to have a substantially L-shaped cross-section, with flanges 14c, 14d the define the outwardly, relatively to the L-shaped cross-section, facing first and second surfaces. In some embodiments, and shown in FIG. 2A, the L-shaped cross-section of the projection 14 may be supported with one or more gussets or ribs 46 extending between each of the surfaces 14a, 14b. The gussets 46 are included to assist in advantageously preventing distortion of the projection 14 during use, as well as to advantageously reduce/minimise the risk of deformation caused by (plastic) shrinkage during manufacture. With reference to the example arrangement of the members 300, 400 shown in FIG. 10, when the guide is 100 used to locate and guide a fastener to secure the members 300, 400 together, the surface 14a is configured to engage and abut/contact a side 320a (or 320b) of the member 300 and the surface 14b is configured to engage and abut/contact a side 420a (or 420b) of the member 400. The thickness and shape of the projection 14 provides rigidity to assist in preventing bending or flexing in use, and thus avoiding inaccuracy in locating the or each receiver 12 (and thus the fastener 200) relative the members 300, 400. Along the length of the projection 14, a number of holes/apertures are also included spaced from one another. The holes are included to reduce the weight and amount of material used to manufacture the projection 14, thus advantageously allowing the guide 100 to be more easily handled by a user thereof and saving on manufacturing cost.

The example projection 14 that defines the surfaces 14a, 14b is a single unitary projection/leg. Alternatively (not shown), for example, the guide 100 may comprise two spaced-apart engagement projections 14, including a first engagement projection defining a surface 14a configured to engage the member 300 and a second engagement projection defining a surface 14b configured to engage the member 400.

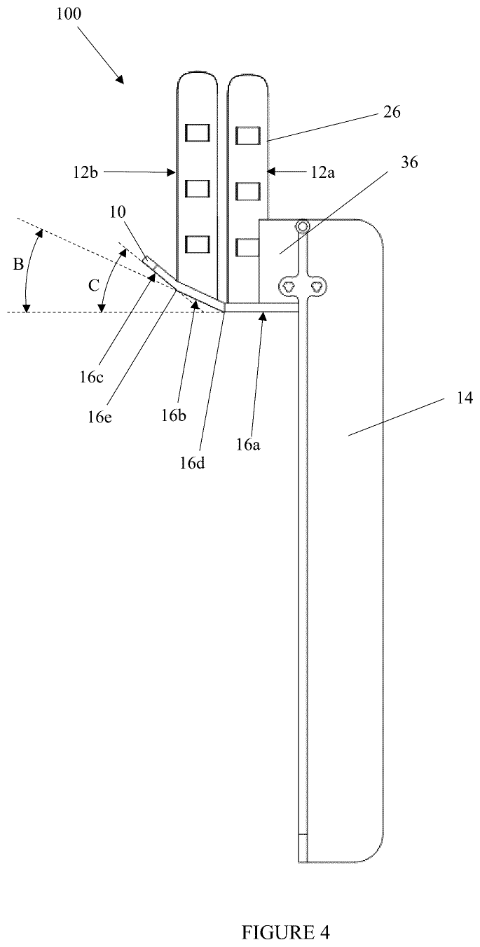

Shown in FIG. 6, the guide may extend a length or distance 14L, from a plane in which the surface portion 16a of the base extends, that corresponds to, for example, around twice the width of a typical member 300 (or 400). By way of non-limiting example only, where the members may be 90 mm×35 mm (such as in Australia) or 90 mm×45 mm (such as in New Zealand), the dimension 14L may be less than or equal to about 250 mm, more particularly less than or equal to about 240 mm, more particularly less than or equal to about 230 mm, more particularly less than or equal to about 220 mm, more particularly less than or equal to about 210 mm. Further, again by way of non-limiting example only, additionally or alternatively, the distance 14L may be greater than or equal to about 150 mm, more particularly greater than or equal to about 160 mm, more particularly greater than or equal to about 170 mm, more particularly greater than or equal to about 180 mm, more particularly greater than or equal to about 190 mm.

The guide 100 may be configured, as will be described below, when used to interconnect member 300, 400, and when at least one of the members 300, 400, and/or the longitudinal axis 704, 706 of, extends in a horizontal plane, such that the axes 702 extend perpendicular to a horizontal plane (i.e., the axes 702 are vertical axes). More particularly, with reference to FIG. 10, when the faces 410, 430 of the member 400 extend in a horizontal plane, the example guide 100 may be configured such that the axis 702 of the receiver 12a extends through or close/near to both (1) a vertical centre-or mid-plane that extends both along the longitudinal axis 706 and generally equidistant from the side faces 420a, 420b, and (2) a vertical centre-or mid-plane that extends both along the longitudinal axis 704 and generally equidistant from the faces 320a, 320b. Further, with reference to FIG. 11, when alternatively the member 400 is arranged so that the faces 420a, 420b extend in a horizontal plane, the example guide 100 may be configured such that the axis 702 of the receiver 12b extends through or close/near to both (1) a vertical centre-or mid-plane that extends both along the longitudinal axis 706 and generally equidistant from the faces 410, 430, and (2) a vertical centre-or mid-plane that extends both along the longitudinal axis 704 and generally equidistant from the faces 320a, 320b.

With reference to FIG. 8, and by way of non-limiting example only, the guide 100 may be configured such that the predetermined distance D10 between a plane in which the surface 14b extends and a parallel plane that extends through the axis 702 of the receiver 12a is about 18 mm, the predetermined distance D20 between a plane in which the surface 14b extends and a parallel plane that extends through the axis 702 of the receiver 12b is about 35 mm, and the predetermined distance D30 between a plane in which the surface 14b extends and a parallel plane that extends through the axes of the receivers 12a, 12b is about 18 mm. With reference to the example uses of the guide 100 to align and guide a fastener as shown in FIGS. 10-17, the surfaces 14a, 14b/in which the surfaces 14a, 14b extend may all be vertical planes. The inventors have found a guide 100 having the example dimensions D10, D20 and D30 set out above are suitable for use with components (e.g. chords, webs) of both typical Australian truss members (width mm 90×thickness 35 mm) and New Zealand truss members (width mm 90×thickness 45 mm). In particular, the inventors have found advantageously a fastener 200 installed using the guide having the above dimensions for D10, D20 and D30 will be sufficiently close to the respective vertical centre or mid-plane and a far enough distance from the adjacent edges, as required may be required under the relevant regulations/codes for connecting together relevant members/components of structural buildings in Australia and New Zealand.

In use, the positioning of the projection 14 relative to the base 10, and the way in which it extends from the base 10, advantageously provide for the correct location of the/each receiver 12 in such a way that guiding a fastener 200 therethrough, along the axis 702, will secure the first structural member 300 to the second 400 and ensure the integrity of the connection thereby formed. With refence to FIG. 10, for example, and as discussed above, the spacing between the projection 14 and the receiver 12a or 12b locates the receiver 12 centrally about the upper (second) face 310 of the first member 300. A longitudinal (and substantially vertical as shown in the Figures) axis of the projection 14 is substantially parallel to a longitudinal (and substantially vertical as shown in the Figures) axis of the receiver 12, which defines a generally cylindrical passage or channel for receiving a fastener 200, and/or a longitudinal axis of a fastener 200 located in the receiver 12. A longitudinal (and substantially vertical as shown in the Figures) axis of the or each projection 14 is substantially perpendicular to the base 10 (and, in particular, the first portion 16a of the locating surface thereof.

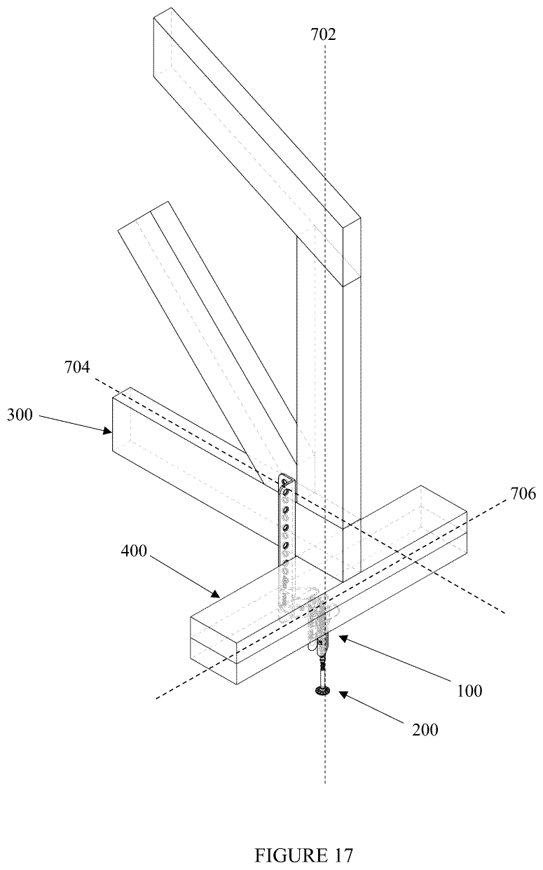

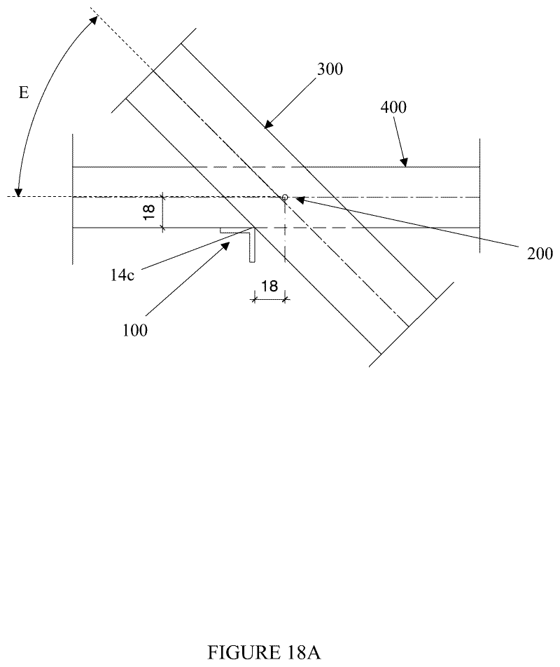

Turning now to FIGS. 19 and 20, some embodiments of the guide 100 may also include instructional text or labels, or other indicia, along or near the receivers 12 (see FIG. 19) and along face or flat portions of the engagement projection 14 (see FIG. 20). The instructional text provides indication to a user of the guide as to which receiver 12a or 12b is suitable to be used to receive the fastener 200 dependent on the type of structural members or type of fixing/securement being accomplished. For example, and as shown in the Figures, one of the receivers 12a is labelled “18 mm” which corresponds to the dimension D10 in FIG. 8, while the other receiver 12 is labelled “35 mm” which corresponds to the dimension D20 in FIG. 8. The instructional text along the projection 14 reads: “18 mm fixing of truncated truss”, and “35 mm fixing of truss to top plate—top down or bottom up”.

With reference to FIGS. 2-6, the projection 14, as well as extending from the surface 16 of the base 10, may also extend in the opposite direction to the surface 16a (that is, in the same direction as the/each receiver 12). Accordingly, when the guide 100 is viewed, for example, with reference to FIG. 10, from above by a user or installer, the user may advantageously be able to more easily ascertain the position of the projection 14 below the base 10 based on this further or additional extension.

Turning back now to FIGS. 1 and 3, the pair of fastener receivers 12a, 12b can be seen extending from the base 10. In the Figures, the receivers 12 extend upwardly from the base 10. The receivers 12 are each for receiving and guiding a respective fastener 200, into the members 300, 400 to securely connect them together. It is contemplated that only one of the receivers 12 at a time. As described, the receivers 12 extend from the base 10 in a direction opposite to the projection 14. When the guide 100 is used, the projection 14 and base surface 16 locate the receiver 12 such that a fastener 200 can be placed therein before being driven into the members 300, 400, with the receiver 12 (the one receiving the fastener 200) ensuring the fastener is correctly located (positioned and orientated) within the members 300, 400. Each receiver 12 is elongate and extends substantially perpendicularly relative to surface portion 16a portion the base 10. In particular, one receiver 12a is positioned such that it generally extends from the base opposite the portion 16a, and another receiver 12b is positioned such that it generally extends from the base 10 opposite the portion 16B. In this way, irrespective of the relative incline (or lack thereof) of the structural member 300, a user can advantageously select a receiver 12a or 12b which extends normally from the base 10. Each receiver 12 has an open end, being the distal (relative to the base 10) end, which is open so to allow the fastener 200 to be introduced into the receiver 12 by inserting the fastener therethrough. Each receiver 12 is sized to receive the fastener 200 without binding thereagainst. What is meant by this is that each receiver 12 is provided slightly oversized relative the intended fastener 200 size, such that there is some tolerance between that receiver 12 and the fastener 200, but with the receiver 12 still configured to effectively guide the fastener 200 along the respective axis 702.

In some embodiments, each receiver 12 may also comprise at least one formation 18 on an inner surface thereof, being the surface against which the fastener 200 contacts when it is placed in the receiver 12. The formation 18, in use, contacts and engages the fastener 200 as it is inserted or placed into, and optionally also driven through, the receiver 12. In some embodiments, while not shown, the guide 100 may include reinforcements between and connecting each receiver 12 to assist in preventing distortion thereof when, for example, the formations 18 contact a fastener 200 in use. The reinforcements may be in the form of additional material of the guide 100 which extends the length of each receiver 12 to provide a structural bridge therebetween. The reinforcements may also assist in minimising the risk of deformation caused by (plastic) shrinkage during manufacture of the guide 100. The formation 18 is provided to prevent the received fastener 200 from travelling/passing entirely through and/or out of the receiver before a user is able locate the guide 100 relative to structural members 300, 400 and drive the fastener 200 into at least one of the members 300, 400. To do so, the formation 18 is configured to prevent the fastener 200 from travelling through the receiver 12 without rotation. With reference to FIG. 3, the at least one formation 18 is advantageously configured for use with and to engage threaded fasteners. The formations 18 may be, for example, in the form of circumferentially extending rib(s) 18a defining one or more female screw threads, or sections of female screw threads, protruding from inner surface(s) of the receiver 12, the female screw threads or sections of female screw threads preferably generally corresponding to male screw threads of the fastener 200. In this way, as the fastener 200 enters the receiver 12, the screw threads fastener 200 contact the formation and are caught thereby, preventing the fastener 200 from travelling axially through and out of the receiver 12. When the fastener 200 is subsequently rotated, the formation(s) 18 preferably generally align with screw threads of the fastener 200, and allow the fastener 200 to travel downwardly and into the member 300. It is contemplated the ribs 18 (and/or other parts of the guide 100) may be formed from a relatively stronger material than the remainer of the guide 100 to avoid premature wear of the ribs 18a resulting from, in use, the ribs 18a engaging/contacting threads of fasteners 200 being driven through the receiver 12. The ribs may be formed from metal, such as steel. During manufacture of the guide, the metal ribs 18a may be located in/or relative to a mould such that when the remainder of the guide 100 is injection moulded from, for example, plastic using the mould, the moulded plastic body of the guide will encapsulate at least part of the ribs 18a and thereby support the ribs 18a in position.

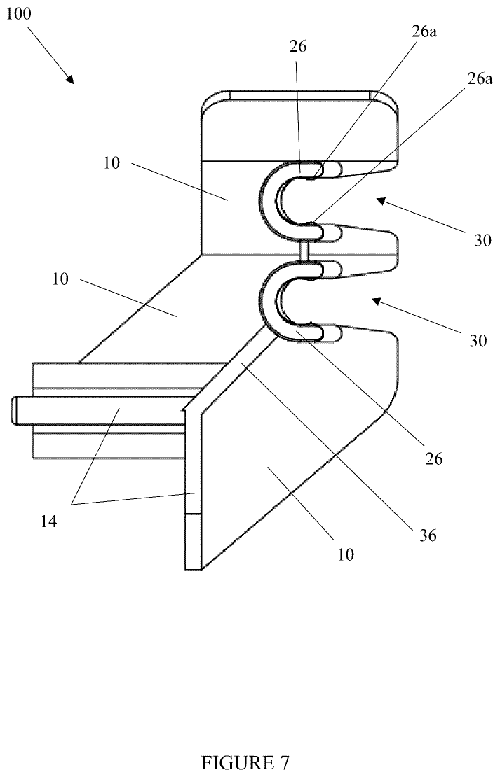

FIGS. 9A and 9B show a fastener 200 partially inserted into receivers 12a (FIGS. 9B) and 12b (FIG. 9B), respectively. Each receiver 12 partially surrounds the fastener 200 in use. What is meant by this is that, rather than fully encompassing or surrounding the fastener 200 in use, the respective receiver 12 includes an opening, in the form of lateral opening 24, along its length/axis 702a such that it only partially surrounds the fastener 200 in use. After the fastener 200, in use, has been partially driven through the respective receiver 12 into and engages at least one of the members 300, 400, the opening 24 allows the guide 100 to be moved laterally away from the fastener 200, whereby the fastener 200 moves relative to and thereby passes through the opening 24, releasing the fastener 200 from the guide 100/respective receiver 12. Each receiver 12 includes at least one retainer in the form of a sidewall (or sidewalls) 26 which define(s) the elongate recess or opening 24 therein. The sidewalls 26 are best seen in FIGS. 8, 9A and 9B. An inner surface or each sidewall 26 may include a part inner cylindrical, semi-circular, or curved portion that corresponds to the shape of the fastener 200 to facilitate retaining and guiding the fastener 200. The side walls 26 retain a received fastener 200 within the surrounds of the receiver 200, thus preventing it from falling out of the receiver 12 such as by tipping over or rotating laterally, in a direction transverse to the longitudinal axis 704 of the receiver 12/fastener 200. The guide 100 further includes one or more one or more grips or similar protrusions 26a that protrude/extend form the sidewalls 26 into and/or at least partly across the opening 24 to retain a fastener 200 in the receiver 12. Each receiver 12a, 12b of the guide 100 includes two axially spaced apart pairs of opposed grips 26b. The sidewalls 26 and/or the grips 26 are configured to resiliently flex to allow a fastener 200 to be loaded into the respective receive 12a, 12b and also sufficiently rigid to thereafter retain the fastener 200 in the receiver 12a, 12b while no external force acts on that fastener 200 (e.g., while the guide 100 is aligned/positioned relative to the members 300, 400 and the user thereof prepares to commence driving the fastener 200 into one or both of the structural members 300, 400). The sidewalls 26 and/or the grips 26 are similarly configured to resiliently flex to allow the fastener 200 to be pushed or pulled out of the respective receiver 12a, 12b, through the opening, during use, after the fastener 200 has been partly driven into one or both the both of the structural members 300, 400.

The fastener 200 shown in FIGS. 9A and 9B may be, by way of non-limiting example only, a relatively course thread framing screw with a preferably relatively large-diameter head configured to receive/engage a hexagonal shaped driver bit (i.e., the fastener may be a hex internal drive fastener). Alternatively, the fastener 200 may comprise other head types, preferably also configured to engage with and/or receive a rotary tool configured to drive the fastener 200 into the members. Preferably, the fastener 200 is one which ends, opposite the head, in a pointed tip, including a self-drilling fastener. Such a fastener 200 is particularly suited to connecting together wooden members of abutting/adjacent trusses, such as those in a common timber-frame residential dwelling. It will be understood, however, that the fastener 200 need not be a framing screw of this type. Furthermore, the fastener 200 could be another type of fastener altogether, being selected relative to the materials of the members of the truss it is to join, for example, another fastener that include a spiral outer thread along its shank, and a head portion having a wider diameter than the shank portion. Alternatively, it is contemplated the fastener could be a nail.

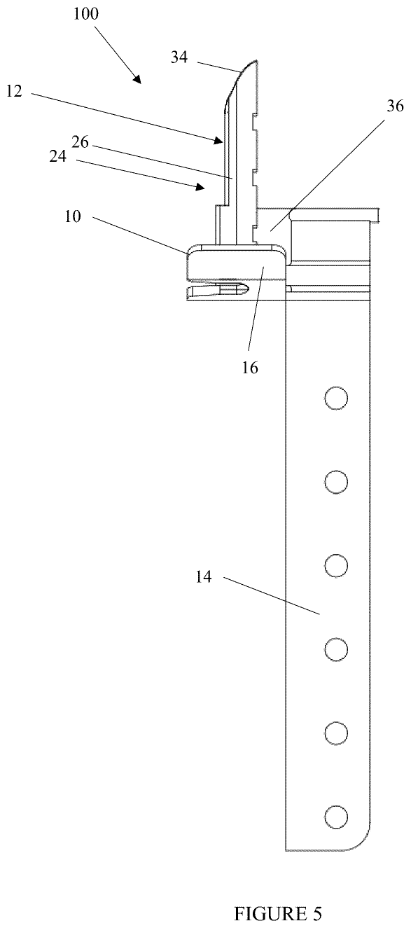

Turning back now to FIGS. 7 and 8, the base 10 includes slots 30 which correspond to and are aligned with and are an extension of the opening 24 in each receiver 12. The slots 30 are sized accordingly to the opening 24, and are included to allow for removal of the fastener 200 from the guide 100, including when the fastener has been at least partially driven into the structural member 300 and is protruding past a lower end of the respective receiver 12 and/or the base 10.

Turning once more to FIGS. 9A and 9B, an open end of each receiver 12 can be seen to also include a ramp 34. An open end of the receiver 12, through which a fastener 200 may inserted/fed into the receiver in a direction towards the base 10, is slanted to form the ramp 34. The ramp 34 is configured to automatically push the guide/receiver away from fastener 200 as the fastener 200 is driven through the guide. In particular, in use, when a fastener 200 moves through the receiver 12, as it is being driven into at least one of the members 300, 400, a head 210 of the fastener bears on/engages the ramp 34, such that head 210 pushes the guide/receiver to move/displace the guide/receiver laterally away from the fastener 200. The ramp includes a surface 34a that extends obliquely relative to the guide axis and that is configured to engage the head of the fastener. Due to the inclusion of the receiver opening 24 and the base slot 30, the fastener 200 can pass/move, relative to the guide, through the opening 24 and slot 30 to thereby disengage and separate the guide 100 from the fastener. Advantageously the ramp 34 is slanted/forms an oblique angle with respect to the axis 702a so to push the guide 100 further away from the fastener 200 as it is driven into the member(s) 300, 400. In exemplary embodiments, the ramp 34 is shaped and sized to displace the guide 100 far enough away from the fastener 200 when a fastener is driven through the receiver 12 such that the head 210 of the fastener does not contact or capture the receiver 12 and/or the base 10 of the guide 100. It is contemplated the ramp 34 may be provided separately from but attached to the open end of each receiver 12, to ensure that, where a fastener 200 includes a head 210 having an abrasive underside, that this underside does not score or damage the open end of the respective receiver 12. That is, it is contemplated, the ramp 200 may be formed from a different, for example stronger/tougher/more wear-resistant/shock absorbing, material than the body of the receiver and be secured to a body of the receiver. Further, the ramp and/or a component thereof may be configured to be replaceable.

To provide structural support and rigidity to the projection 14 and/or receivers 12, the body of the guide 100 also includes at least one support formation 36. The support 36 preferably connects the base 10 to each receiver 12 and projection 14, thus supporting the extensions of each. In this way, the support 36 acts as and/or comprises strengthening gusset(s) or webbing between the components or features of the guide 100. In alternative embodiments, a separate support 36 may be provided between the base and each of the receivers 12 and the projection/s 14. Alternatively, a sole support 36 extending from the base 10 to both or one of the receivers 12 and or another sole support 36 extending from the base 10 to the projection 14 may be included. A user may also utilize the support(s) 36 by pushing against them to assist in locating the guide 100 by engaging the projection 14 with face(s) of the member(s) 300, 400.

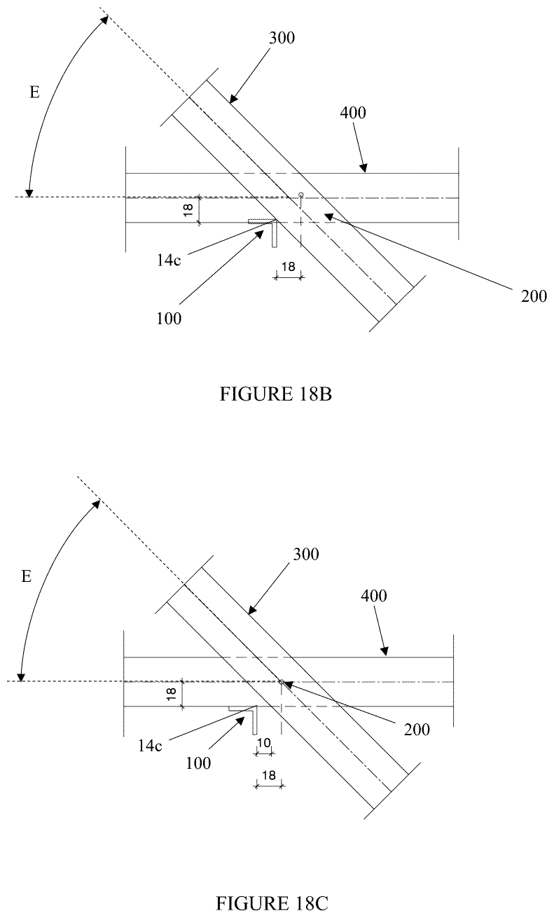

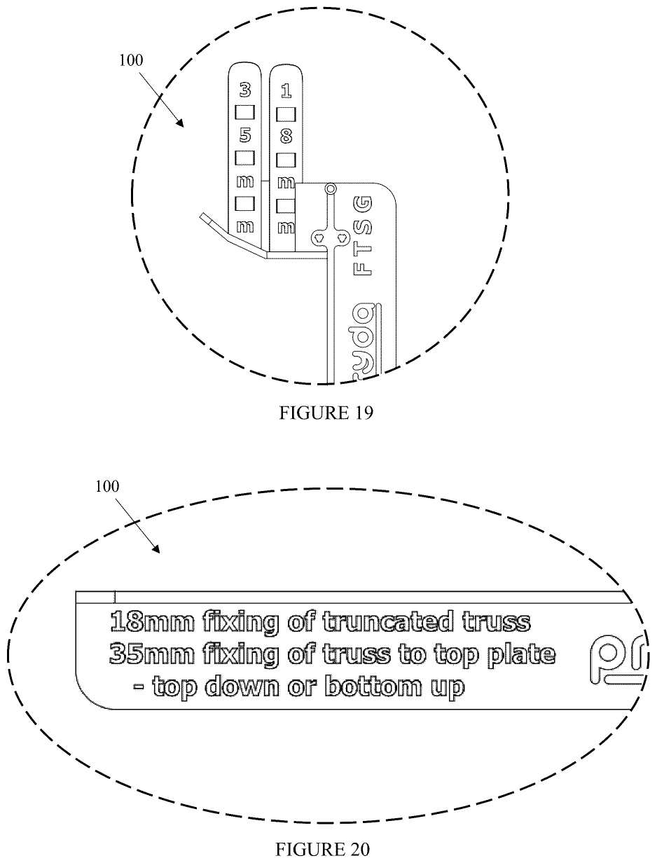

Installation, assembly and/or construction of a building framework, for example to install roof trusses, as will be discussed below, may be tiring work, and it is not uncommon for workers to wish to avail themselves of liquid refreshments upon completion of work and/or at the end of a working day/shift. To this end, the example guide 100 shown in FIGS. 21 and 22 also includes a bottle opening means/structure 38. The bottle opening means 38 is a feature with which a user of the guide 100, when not guiding fasteners 200 therewith, can operate the guide 100 to remove a crimp-style bottle cap 610 from a bottle 600, such as a cap found on beer bottles, for example. In FIG. 20, the projection 14, more particularly the flange 14d, includes a pair of spaced-apart apertures 40 formed/arranged on opposite sides of the projection 14/flange 14d. The substantially parallel-extending cylindrical, advantageously threaded, apertures 40 are configured to receive and retain threaded-shank portions of a pair of correspondingly threaded fasteners, and include a depth such that portions of the fasteners, including head portions thereof, remain extending from the apertures 40 when received thereby. Alternatively, the apertures 40 may be configured to receive alternative fasteners. For example, the apertures 40 may be configured to each similarly snugly receive and retain a nail or similar fastener (e.g., by interference of press fit). FIG. 21 schematically shows operation of the bottle opening means 38, whereby the heads of the fasteners extending from the apertures 40 can be disposed beneath the rim of a bottle cap 610, before being levered using the guide 100 to remove the cap 610 from the bottle 600. In the embodiment shown in the Figures, the fastener is a threaded fastener with a head having a substantially flat undersurface (such as, for example, a round, truss, or otherwise non-countersunk screw head). In this way, the undersurface of the head of the (or both) fasteners catches the underside edge of the bottle cap 610 and allows the fasteners to assist in the removal of the cap 610 from the bottle 600. As the guide 100 is levered, a formation 42, such as a small protrusion or knob of the guide 100, positioned spaced from the apertures 40 and above the apertures 40, as seen in FIG. 21, acts as/defines a pivot point or fulcrum, contacting the bottle cap 610 and allowing the guide 100 to lever around the pivot point to remove the cap 610.

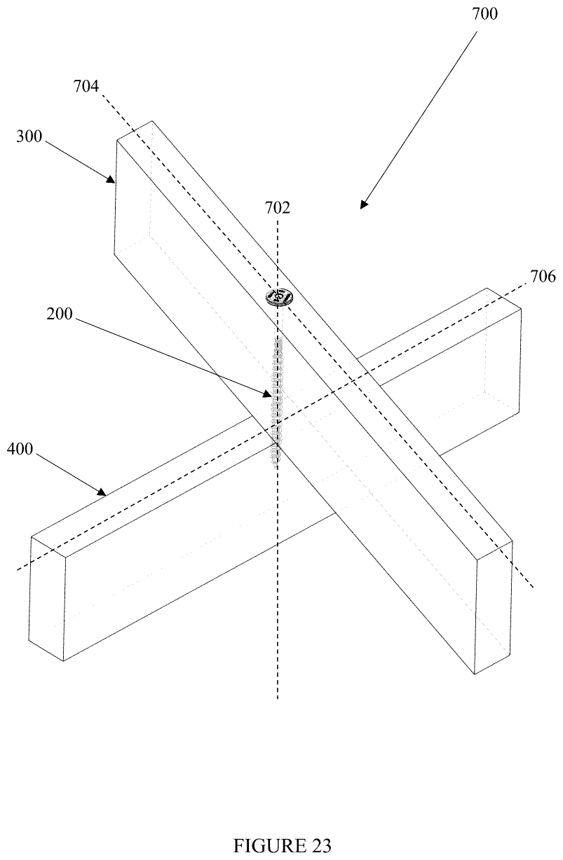

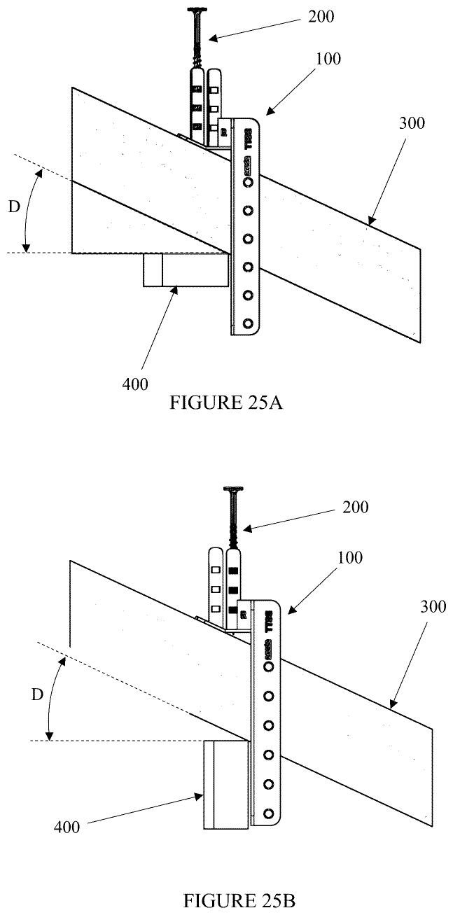

A method 500 of securing a first structural member 300 to a second structural member 400 to thereby form a connection 700 between the members 300, 400, using a guide 100 as described herein, will now be described with reference to FIGS. 10, 11 and 23-33.

In accordance with the method 500, and with reference to FIG. 10, the first structural member 300 to be, for example, fixed against an in situ second structural member 400 is located/positioned in a selected location/position relative to the first structural member 400. The structural members 300, 400 may be arranged to directly abut with and contact each other, or alternatively with an intermediate member, or component or substrate/layer, therebetween.

As previously discussed, again with reference to FIG. 10, and by way of non-limiting example only, the first member 300 may be an extension of a top chord (or other component, such a bottom chord of a heel) of a first truss that extends in a first plane, and the second member 400 may be a top chord (or other component) of a second truss that extends in a second plane, the first plane extending transversely, substantially perpendicularly, relative to the second plane. In FIG. 10, member 300 extends in a plane that is substantially perpendicular with a plane in which the second member extends. Alternatively, with reference to FIG. 11 and again by way of non-limiting example only, the member 400 may be a top plate. The top plate may comprise abutting top plate components 400a, 400b aligned, abutting and/or secured relative to one another.

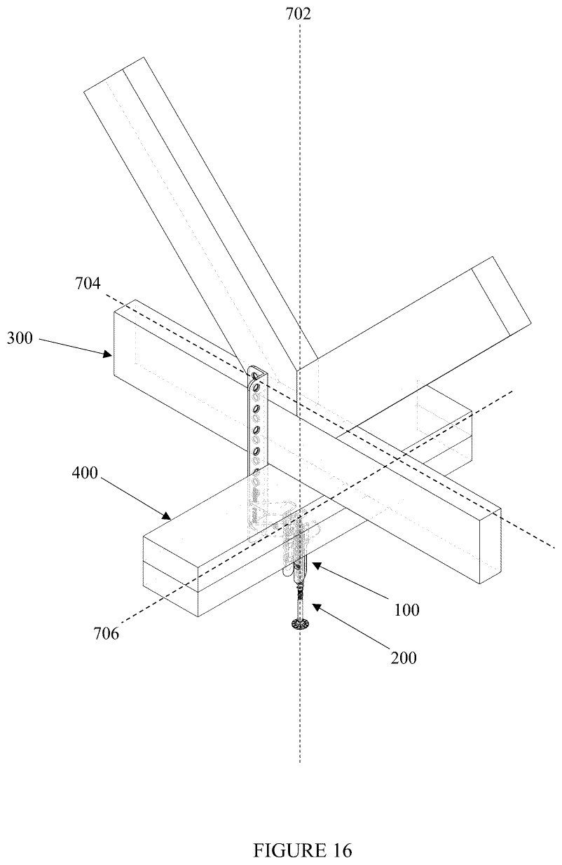

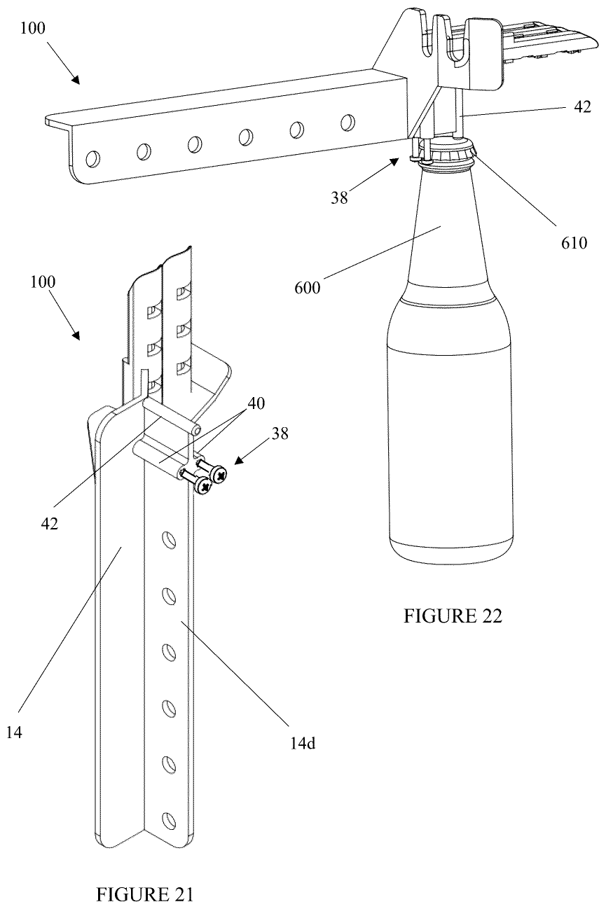

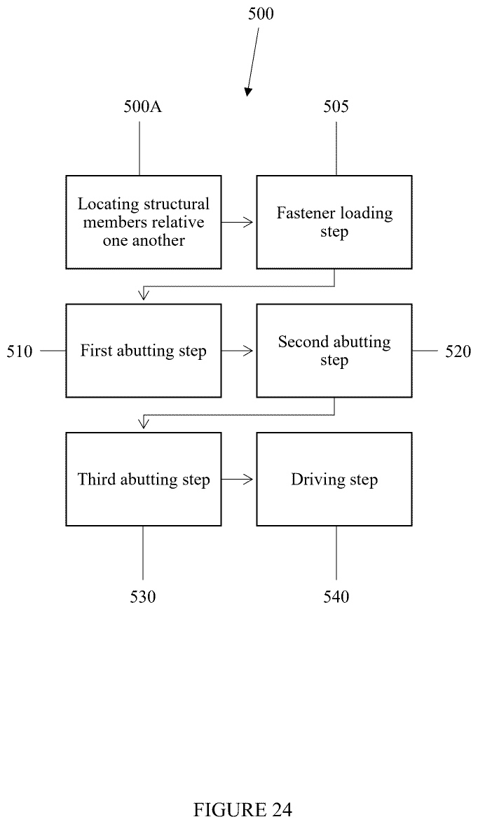

In the arrangement shown in FIG. 10, and similarly in the arrangement shown in FIG. 11, the longitudinal axis 704 of the first elongate member 300 extends obliquely with respect to a longitudinal axis 706 of the second elongate member 400, with the face 330 of the member 300 abutting or engaging, or resting on, the longitudinally extending edge 420 of the (top FIG. 11) face 410 of the structural member 400. In particular, the longitudinal axis 704 of the member 300 extends obliquely relative to a plane of the face 410; and the longitudinal axis 706 of the member 400 extends perpendicular relative to planes of the side faces 320a, 320b. With reference to FIGS. 10, 25A and 25B, the longitudinal axis 704 may make an Angle D with the plane of the face 410 that corresponds to the Angle B and is, for example, about 25 degrees. Alternatively (not shown), for example, the longitudinal axis 704 of the member 300 may extend perpendicularly with respect to the longitudinal axis 706 of the member 400, and/or (see FIGS. 18a-c-18c) the longitudinal axis 706 may extend obliquely relative to planes of the side faces 320a, 320b. Positioning or locating of the structural members 300, 400 relative one another can be seen as a preliminary or earlier step undertaken in the method 500, shown in FIG. 23 as step 500A.

To ensure the integrity of the connection 700 between the structural members 300, 400 as shown in FIG. 10, when applying a fastener 200 by driving the fastener through the face 310 of the first structural member 300 along the axis 702a into the structural members 300, 400, it may be preferable that (1) the fastener 200 is positioned and orientated such that the axis 702a/direction along which the fastener 200 is driven extends in a vertical direction that is substantially perpendicular to the horizontally extending member 400. It may also preferable, particular when only a single fastener is used to form the connection, (2) that the fastener 200 is positioned and orientated such that the axis 702a/direction along which the fastener 200 is driven into the members 300, 400 extends between (and spaced from) the faces 320a, 320b and between the faces 420a, 420b. For example, through/substantially within or near a plane that extends both along the longitudinal axis 704 and generally equidistant from the faces 320a, 320b, and through/substantially within or near a plane that extends both along the longitudinal axis 706 and generally equidistant from the faces 420a, 420b.

In accordance with the method 500, a user then locates, or places or inserts or feeds, a fastener into a selected one of the receivers 12a, 12b of the hand-held guide 100, through the open end of the receiver 12a, 12b distal the base 10 and/or through the opening 24. The guide 100, having multiple spaced apart receivers 12a, 12b that define respective guide axis located at different respective distances D10, D20 from a plane of the surface 14a, is advantageously configured so that either the receiver 12a or the receiver 12b can be used depending on the orientation of the member 400. In particular, when the member 400 is orientated such that the wider face 410 (or 430) extends in a plane parallel to the axes 702a (as in FIG. 10, FIG. 25B), the fastener may be loaded into and driven through the receiver 12a. Alternatively, when the member 400 is orientated such that the narrower face 410 (or 430) extends in a plane perpendicular to the axes 702a (as in FIG. 11, FIG. 25A), the fastener may be loaded into and driven through the receiver 12b. That is, the user is able to select a suitable receiver so that, in use, the fastener will be correctly positioned and orientated to extend through or near a centre of the width and/or thickness of the member 300, 400.

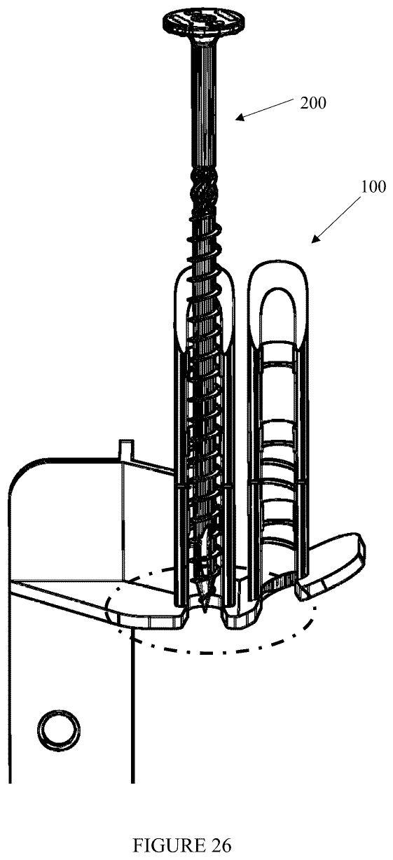

In an abutting/locating step 510 schematically illustrated in FIG. 27, a user making the connection between the members 300, 400, holds the guide 100 such that the faces 14a, 14b of the projection 14 extend in substantially vertical planes, and moves the guide 100 to firmly press the face 14a against the vertical face 320a (or face 320b) of the member 300 to be secured to/fixed against the in situ member 400. The face 14a of the guide 100 abuts/contacts and locates against the vertical face 320a such that the face 14a also extends in a vertical plane, substantially coplanar with the face 420a.

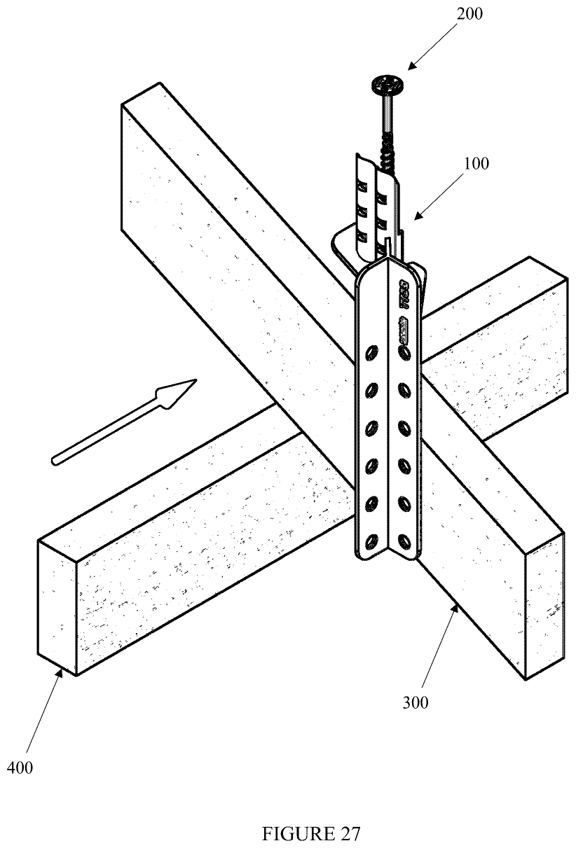

Following step 510, in a second abutting/locating step 520 schematically illustrated in FIG. 28, the user holding the guide 100 moves/slides the guide 100 in a direction along a plane of the face 320a towards the face 420a (or face 420b) of the in-situ member 400 to firmly press the face 14b against the vertical face 420a (or face 420b) of the member 400. The face 14b of the guide 100 abuts/contacts and locates against the vertical face 420a such that the face 14b also extends in a vertical plane, substantially coplanar with the face 420a.

Following steps 510 and 520, surfaces 14a, 14b, being planar surfaces, substantially abut, face-to-face, with the respective faces 320a, 420a, such that the receivers 12 and the projection 14 of the guide 100 extend both perpendicularly with respect to the faces 410, 430 and vertically.

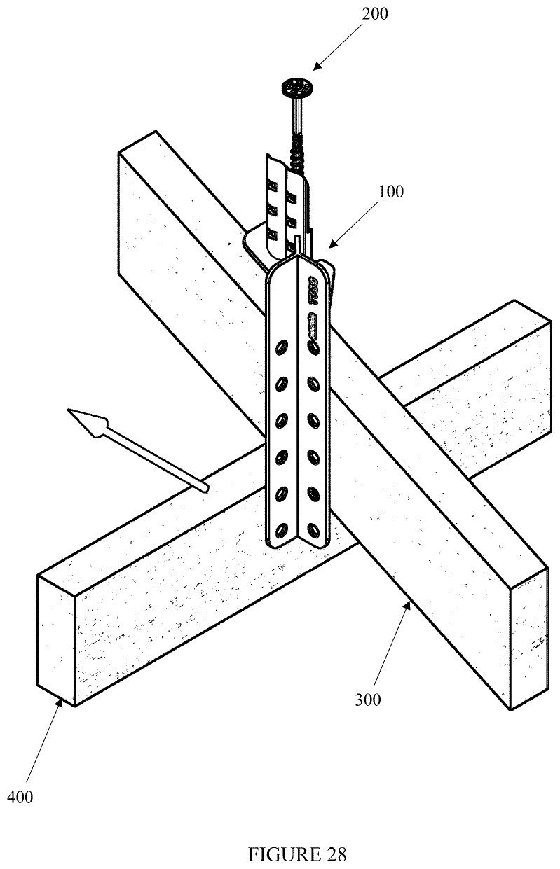

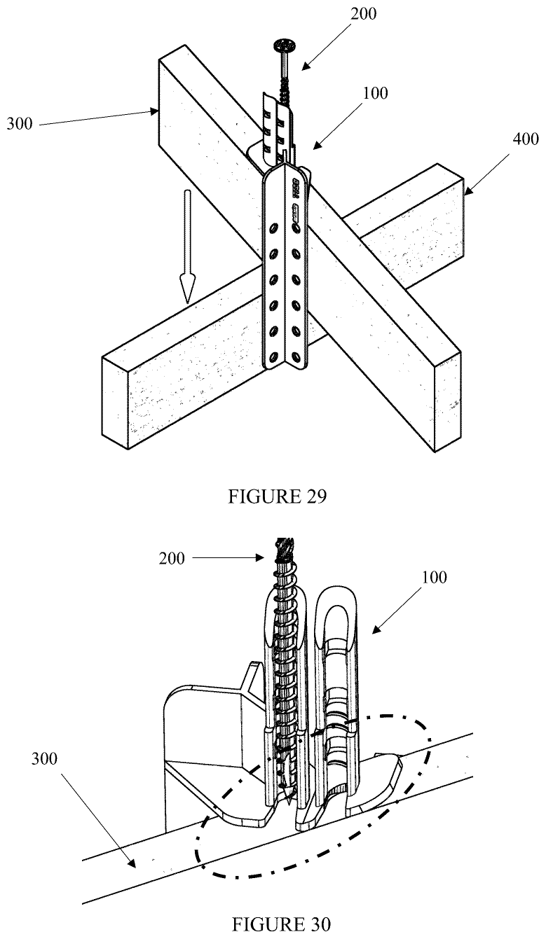

Following steps 510 and 520, in a third abutting/locating step 530 schematically illustrated in FIGS. 29 and 30, the user holding the guide 100 so as to firmly abut/press against the faces 320a, 420a, moves/slides the guide 100, in particular the portion 16b thereof, downwardly to firmly press the portion 16b against the top face 310 of the member 300. The portion 16b of the surface 16 of the base 10 contacts, and abuts and locates against, the face 310 such that the portion 16b extends substantially coplanar with the face 310, and with the axes 702a extending vertically.

It will be understood that the fastener 200 may be placed/loaded into the receiver before, following, or even during, any of the steps 510, 520, 530. It will also be understood the order of the steps may be adjusted. For example, the step 510 may occur after or substantially simultaneously with/at the same time as the step 520, and the step 530 may occur after or substantially simultaneously with/at the same time as the step 510 and/or the step 520. FIG. 23 shows a fastener loading step 505 undertaken before each of steps 510, 520 and 530. The fastener loading step 505 comprises clipping the fastener 200 into a receiver 12a or 12b of the guide 100 such that the fastener's) point/end does not protrude down past the base surface 16 of the guide 100.

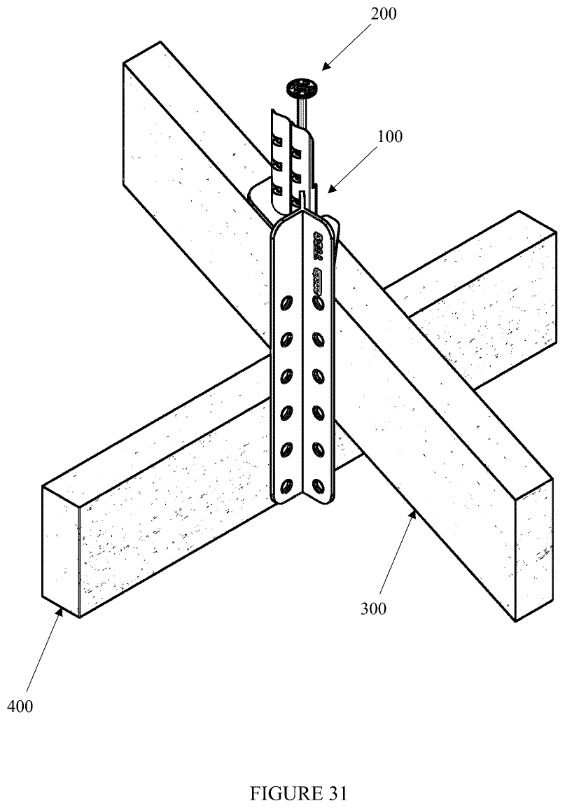

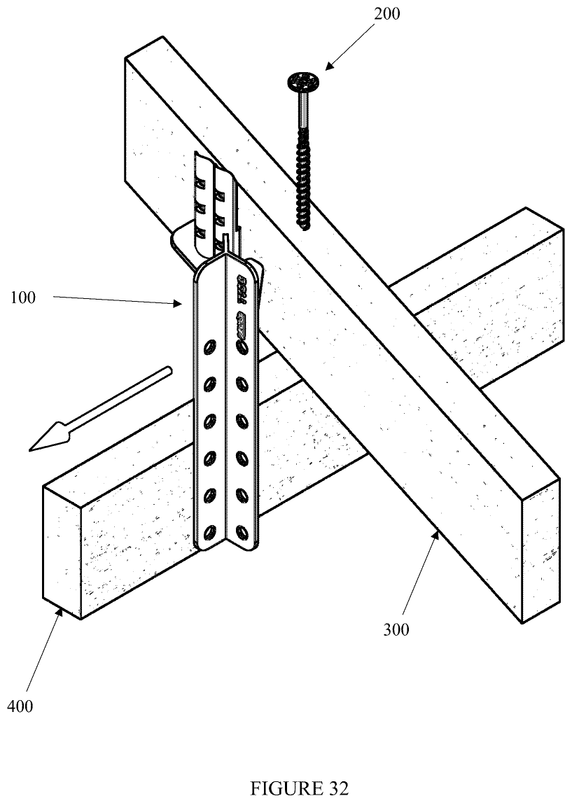

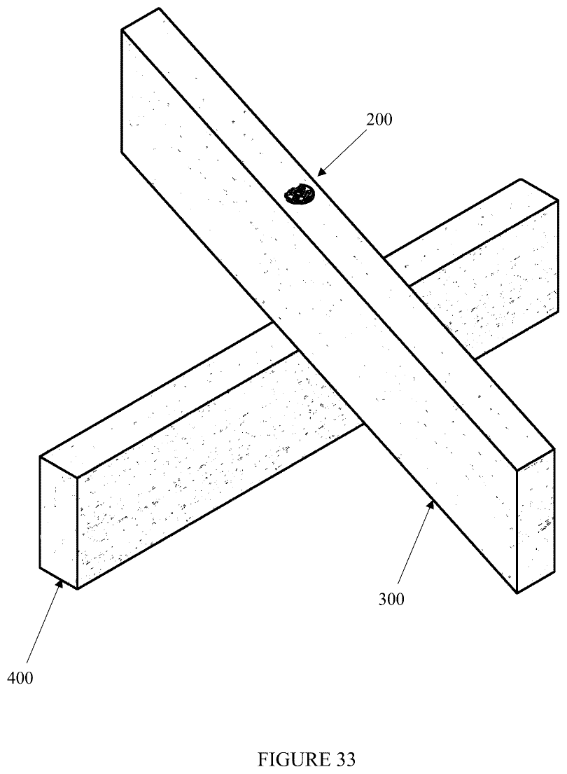

Following steps 510, 520 and 530 (and 505), with the receiver 12 correctly located relative to the members 300, 400, in a driving step 540 schematically illustrated in FIG. 31, the user guide firmly holds the guide 100 against the faces 310, 320a and 420, and drives, for example rotatably drive using a powered rotary tool, the fastener through the receiver 12a, along the guide axis 702 and into and through the member 300 and into the member 400, to thereby form the connection 700 between and secure together the members 300, 400. During the driving step 540, the guide 100 can be removed from the fastener 200 by pulling the guide 100 laterally away therefrom, and/or the guide 100 will be pushed away from the fastener 200 when the ramp 34 engages the head of the fastener 200 as the fastener 200 is driven through the receiver 12 (as illustrated in FIG. 32). Thus, at completion of the final driving step 540, each member 300, 400 of the truss is secured together, with the fastener positioned as shown in FIG. 33.

Advantageously, during steps 510-540, the user needs only to hold the guide 100 with a fastener at least partly located and retained within in a receiver thereof, and not both the guide 100 and the fastener 200 separately. This may be important when the guide 100 is being used at height, where there is a risk of the user falling and injuring themselves. Additionally, the provision of the formation(s)/internal thread section(s) 18 and the sidewalls 26 enables the user to keep their fingers a safe distance away from the fastener 200 as it is being driven into the structural member, while ensuring the fastener 200 does not become misaligned within the respective receiver 12.

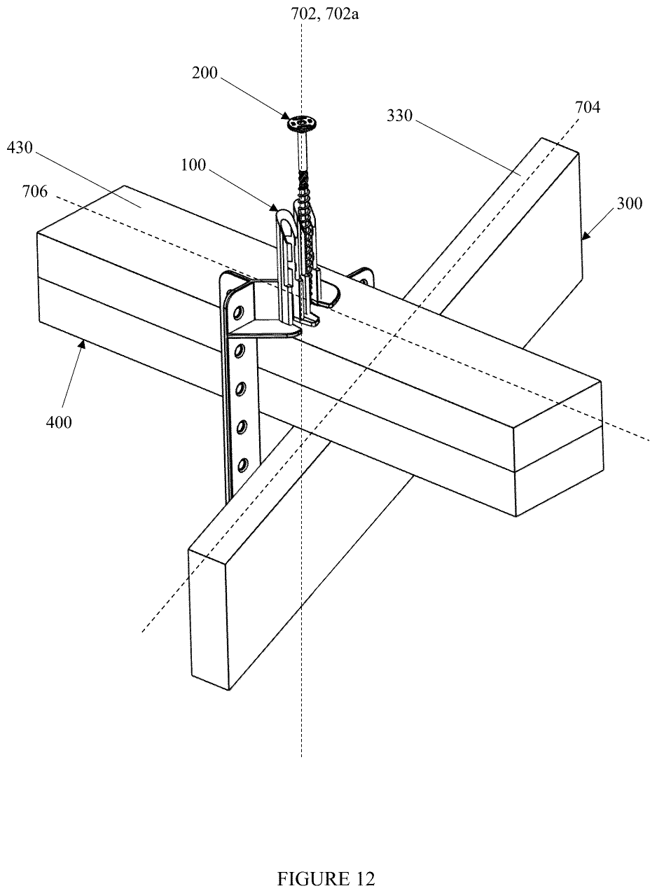

It will be understood that alternatively, a user may instead locate the guide 100 relative to the members 300, 400 with the base 10 generally located under/below the horizontally extending member 400. See, for examples the arrangements in FIGS. 12 and 13 (which show the members 300, 400 upside down/inverted), and FIGS. 14-16. When, the guide 100 is used to secure the members 300, 440 with the base 10 located under/below the horizontally extending member 400, in step 530 the user can move/slide the guide 100 upwardly to firmly press the portion 16b of the surface 16 of the base 10 against the bottom face 430 of the member 400. The portion 16b will contact, and abut and locate against, the face 430 such that the portion 16b extends substantially coplanar with the face 430, and with the axes 702a extending vertically.

In accordance with the method 500, example installation instructions will now be described. First, the user may clip the fastener 200, such as a screw, into the guide 100 so that its point/end does not protrude down past the base surface 16 of the guide 100. Next, with the guide 100 held approximately vertical, the user can press the face 14a of the engagement projection 14 against the first structural member 300 to be fixed. Following this, the guide 100 can be moved/slid, in a direction toward the second structural member 400 until the other face 14b of the engagement projection 14 contacts and is firm over its length with both of the member's 300, 400 faces. The guide 100, at this point, should be substantially vertical and have both of its engagement projection faces against the two vertical faces of the members 300, 400. With the guide 100 held firmly against both vertical faces as described, the user can move/slide the guide 100 downwardly until the base thereof contacts the top surface of, for example, the member 300 to be fixed in position. The fastener 200 can then be driven through the guide 100 into at least one of the members 300, 400. Before the fastener 200 is completely driven downwardly into the first member 300, and the head of the fastener enters the receiver 12, the guide 100 can be removed by moving it away from the fastener 200 and thus releasing the fastener 200 from the receiver 12 of the guide 100. Finally, the fastener 200, free and spaced from the guide 100, can be driven home, such as until the head of the fastener is substantially flush with (or partially countersunk within) the face of the first member 300.

As will be understood by the person skilled in the art, the portion 16a, during use of the example guide 100, may be used to engage/abut a horizontally extending face (See FIGS. 12 and 13), the portion 16b may be used to engage/abut a face that extends at an Angle B (e.g. about 25 degrees) to the horizontal (see FIGS. 10 and 11), and the portion 16c may be used to engage/abut a face that extends at an Angle C (e.g. about 45 degrees) to the horizontal. Further, edges or corners, which may be radiused or curved edges or corners, at the transitions between the portions 16a, 16b and 16c additionally allow for situations where the surface 16 of the base 10 is required to engage a face that extends at an angle relative to the horizontal that is between 0 degrees and 25 degrees (by engaging the edge/transition between 16a and 16b, shown as 16d in FIG. 4), and at an angle of between 25 degrees and 45 degrees (by engaging the edge/transition of 16b and 16c, shown as 16e in FIG. 4). It will be understood, when the guide 100 is used so that the edge/transition 16d engages a top or bottom face (e.g. extending between 0 and 25 degrees relative to the horizontal), a small gap will be present between the engaged face and at least part of the portion 16a of the surface 16 adjacent the edge 16d. Similarly, when the guide 100 is used so that the edge/transition 16e engages a top or bottom face (e.g. extending between 25 and 45 degrees relative to the horizontal), a small gap will be present between the engaged face and at least part of the portion 16b of the surface 16 adjacent the edge 16e.

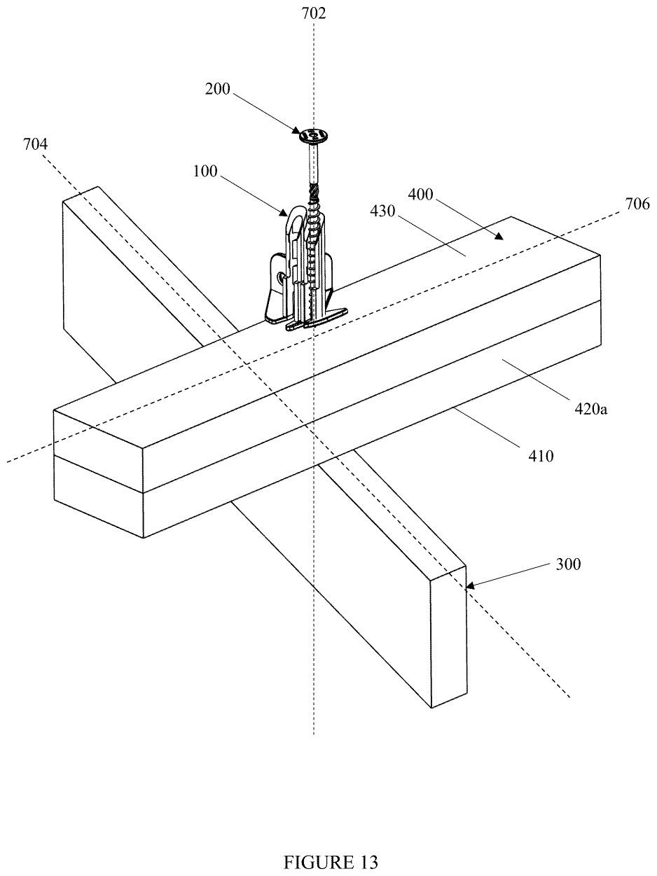

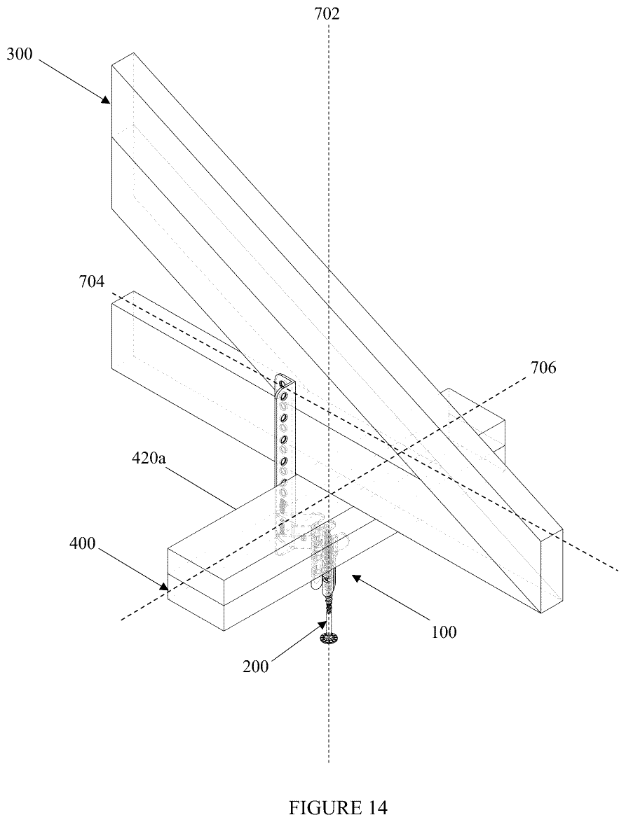

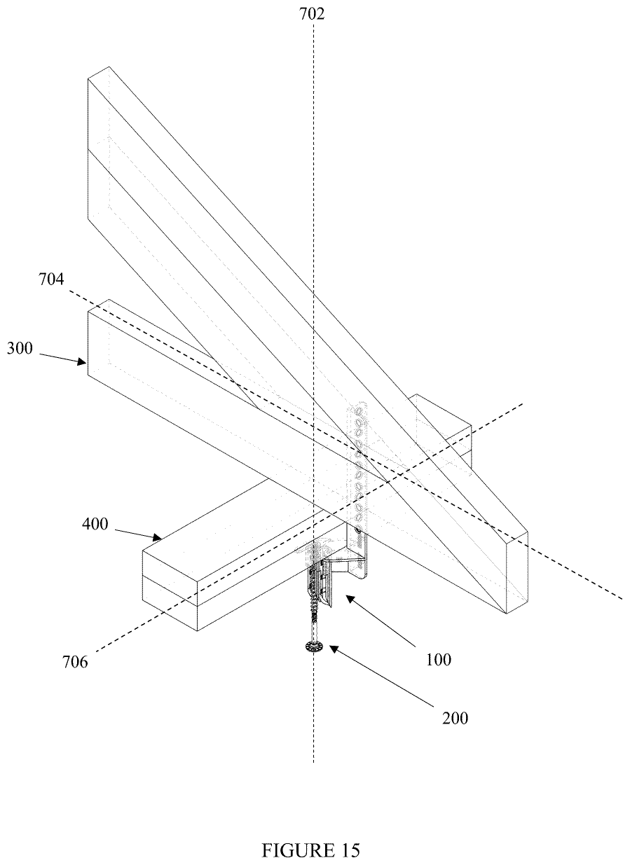

Some example/possible connections 700 formed by driving, or applying or installing, an elongate fastener 200 into structural members 300, 400 using the guide 100 to correctly position and align the fastener 200 are shown schematically in FIGS. 10-17. The example connections 700 shown include: a rafter extension to a truncated truss horizontal top chord (FIG. 10); a rafter extension to a top plate (FIGS. 11-13, shown from below the top plate/upside down in FIGS. 12 and 13); a truss heel to a top pate (FIG. 13, shown upside down); a cantilevered support to a top plate (FIGS. 14 and 15); internal supports to a top plate (FIG. 16); and trusses with an upstand to a top plate (FIG. 17). Advantageously, the guide 100 is configured for use on either side of the member 300 or on either side of the member 400 (compare, for example FIGS. 12 and 13).

Looking to FIGS. 18A, 18B and 18C, other examples of the guide 100 being used to secure structural members 300, 400 together are shown (with the members extending horizontally and being shown in plan/top view), wherein no vertical faces of one of the members 300, 400 are perpendicular (i.e., at right angles) to vertical faces of the other of the members 300, 400. While the guide is particularly suitable for use to secure structural members 300, 400 with a vertical face 320a, 320b of one of the members 300 being perpendicular to a vertical face 420a, 420b of the other of the members 400, it can be seen that the guide 100 is also capable of securing members arranged as shown in FIGS. 18A, 18B and 18C. In such an application, a surface of one of the locating projections 14a or 14b can abut one of the structural members 400, while an edge or corner portion 14e of/between one or both of the surfaces 14a, 14b, where the surfaces 14a, 14b intersect, can abut the other structural member 300. In FIGS. 18A-18C, the member 300 extends in a horizontal direction at an Angle E of about 45 degrees relative to the longitudinal axis of the member 400. Where the example guide 100 is being used with typical New Zealand truss members, having a width W300/W400 of about 90 mm and a thickness T300/T400 of about 45 mm, this advantageously results in the fastener 200 being installed approximately centrally in the members 300, 400 and thus provides a secure connection (shown in FIG. 18A). Where the guide 100 is being used with typical Australian truss members, having a width W300/W400 of about 90 mm and a thickness T300/T400 of about 35 mm, however, this results in an offset or non-centred installation of the fastener 200 (shown in FIG. 18B). Accordingly, where used with typical Australian truss members 300, 400, an installer can space the edge or corner 14e between the locating projections 14a, 14b from the structural member 300 by 10 mm (such as by using a spacer in the form of a block) to position the guide 100 such that its installation will be approximately central to the structural members (shown in FIG. 18C).

Summarily, it is to be understood that the guide as described herein provides several performance advantages and installation improvements over typical, existing truss securements. In particular, the arrangement of the guide's engagement projection and fastener receiver results in a guide which allows for faster, safer, more accurate and higher quality fastening of members of a truss using a fastener.

While various embodiments of the present disclosure have been described above, it should be understood that they have been presented by way of example only, and not by way of limitation. It will be apparent to a person skilled in the relevant art that various changes in form and detail can be made therein without departing from the spirit and scope of the present disclosure. Thus, the present disclosure should not be limited by any of the above described exemplary embodiments.

In an alternate embodiment of the guide 100 (not shown), the guide 100 may include spaced-apart first and second projections 14 configured to straddle the each abut separates sides of the structural member 300 to locate the receiver 12. The projections 14 are advantageously spaced from one another by approximately the same width as, or slightly wider than, the structural member with which they are intended to be used. For example, where the structural member has a width of 35 mm, such an in a typical Australian timber truss member, the projections 14 are spaced apart by at least about 35 mm. Likewise, where the structural member has a width of 45 mm, such as in a typical New Zealand timer truss member, the projections 14 are spaced apart by at least about 45 mm. In this way, the guide 100 straddles the member 300, with a first projection 14 abutting or engaging a third face 320 thereof, and a second projection 14 abutting or engaging a fourth face 320 thereof. Where the guide 100 includes such a pair of projections 14, abutment/engagement of the sides of the member 300 can be affected by placing the base surface 16 into abutment with the top or second face 310 of the member, and then rotating the base guide 10 about its vertical axis to cause the projections 14 to each engage/abut their respective sides/faces of the member 300.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

1. A guide for installation of a fastener to secure structural members, the guide comprising:
a base having a surface configured to abut a first structural member;
an engagement projection extending from the surface of the base and configured to abut a side of the first structural member; and
a fastener receiver extending in a direction opposite from the surface of the base such that when the base and projection are each abutting the first structural member, the fastener receiver is located to guide a fastener placed therein to secure the first structural member and a second structural member together, and such that after the fastener secures the first and second structural members together, the guide is removable therefrom.

2. The guide of claim 1, wherein the engagement projection is configured to abut a side of the second structural member when the side of the first structural member extends perpendicularly relative to the side of the second structural member.

3. The guide of claim 1, wherein the fastener receiver is configured to guide the fastener along a guide axis when the fastener is driven through the fastener receiver to secure the first and second structural members together.

4. The guide of claim 3, wherein the surface of the base comprises a portion that extends perpendicularly with respect to the guide axis to be engageable with a structural member that extends perpendicularly with respect to the guide axis.

5. The guide of claim 3, wherein the surface of the base comprises a portion that extends obliquely with respect to the guide axis to be engageable with a structural member that extends perpendicularly with respect to the guide axis.

6. The guide of claim 3, wherein the fastener receiver defines a lateral opening through which the fastener can be pass through and such that as the fastener secures the first and second structural members together, the guide is removable from the fastener.

7. The guide of claim 6, wherein the lateral opening is an elongate opening that extends along the guide axis.

8. The guide of claim 6, wherein the base defines a slot that is aligned with the lateral opening to enable the removal of the guide from the fastener as the fastener secures the first and second structural members together.

9. The guide of claim 1, wherein the fastener receiver defines an elongate recess positioned to receive the fastener.

10. The guide of claim 9, wherein the fastener receiver includes a sidewall that at least partly defines the elongate recess.

11. The guide of claim 10, wherein the fastener receiver has an open end distal to the base, the open end defining an opening through which the fastener can be introduced into the elongate recess.

12. The guide of claim 11, wherein the fastener receiver incudes a ramp located at or near the open end, the ramp configured to engage and laterally displace a head of the fastener when the fastener is driven through the fastener receiver to secure the first and second structural members together, and thereby displace the guide laterally relative to the fastener.

13. The guide of claim 11, wherein the open end of the fastener receiver includes a ramp surface configured to engage a head of the fastener, the ramp surface extending obliquely relative to the guide axis.

14. The guide of claim 1, wherein the fastener receiver is an elongate receiver that extends longitudinally from the base in a direction opposite to engagement projection.

15. The guide of claim 1, wherein the fastener receiver extends in a perpendicular direction relative to the base.

16. The guide of claim 1, wherein the engagement projection includes a pair of projections, the pair of engagement projections configured to abut opposed sides of the first structural member to locate the receiver relative to the first structural member.

17. The guide of claim 1, which includes one or more supports connecting the base to the receiver and/or to the engagement projection to support the extension of the receiver and/or the projection from said base.

18. The guide of claim 17, wherein the engagement projection includes a surface configured to abut the side of the first structural member, wherein the fastener receiver includes two or more fastener receivers, and wherein said fastener receivers are spaced apart in a direction perpendicular to said surface such that the fastener receivers define respective guide axes that are located at predetermined respective distances from said surface.

19. A guide for guiding a fastener for connecting first and second structural members together, the first structural member having: one face that engages the second structural member, a second face which, in use, is penetrated by the fastener, and third and fourth faces located laterally of the first and second faces, the guide comprising:
a base;
a fastener receiver; and
an engagement projection;
wherein the base and the engagement projection are configured such that the base is engageable with the second face, and the engagement projection is engageable with the third face or with the fourth face.
